(19) United States
(12) Patent Application Publication
(10) Pub. No.: US 2026/0048815 A1
(43) Pub. Date: Feb. 19, 2026

(54) HUMAN-POWERED VEHICLE COMPONENT AND HUMAN-POWERED VEHICLE SYSTEM

(71) Applicant: SHIMANO INC., Sakai City (JP)

(72) Inventors: Hiroaki TAKESHITA, Sakai City (JP); Atsushi ONUMA, Sakai City (JP); Fumihide NUMATA, Sakai City (JP); Tomohiro TAKIMOTO, Sakai City (JP); Akihiro NOZAKI, Sakai City (JP)

(73) Assignee: SHIMANO INC., Sakai City (JP)

(21) Appl. No.: 18/806,703

(22) Filed: Aug. 16, 2024

(51) Int. Cl. B62M 25/08; B62M 6/45; B62M 9/122

(52) U.S. Cl. CPC B62M 25/08; B62M 6/45; B62M 9/122

(57) ABSTRACT

A human-powered vehicle component comprises wireless communicator circuitry and electronic controller circuitry. The electronic controller circuitry is configured to receive a first signal from the additional wireless communicator circuitry via the wireless communicator circuitry. The electronic controller circuitry is configured to change the communication protocol of the wireless communicator circuitry from a second communication protocol to a first communication protocol based on the first signal in a case where the first signal includes first information indicative of the first communication protocol. The electronic controller circuitry is configured to control the wireless communicator circuitry to maintain use of the second communication protocol in a case where the electronic controller circuitry does not receive, via the wireless communicator circuitry, the first signal including the first information indicative of the first communication protocol.

### BACKGROUND

### Technical Field

The present invention relates to a human-powered vehicle component and a human-powered vehicle system.

### Background Information

In recent years, some human-powered vehicles are provided with electric components or devices to make it easier for the rider to operate the human-powered vehicle. Such electric components wirelessly communicate. In a case where a communication protocol of the electric component is updated, for example, the electric component may be unable to communicate with another electric component due to different communication protocols. One of objects of the present disclosure is to improve the usability of the human-powered vehicle component.

### SUMMARY

In accordance with a first aspect of the present invention, a human-powered vehicle component comprises wireless communicator circuitry and electronic controller circuitry. The wireless communicator circuitry is configured to communicate wirelessly with additional wireless communicator circuitry of an additional human-powered vehicle component. The electronic controller circuitry is electrically connected to the wireless communicator circuitry and is configured to receive a first signal from the additional wireless communicator circuitry via the wireless communicator circuitry. The electronic controller circuitry is configured to store a first communication protocol and a second communication protocol as a communication protocol of the wireless communicator circuitry. The electronic controller circuitry is configured to change the communication protocol of the wireless communicator circuitry from the second communication protocol to the first communication protocol based on the first signal in a case where the first signal includes first information indicative of the first communication protocol. The electronic controller circuitry is configured to control the wireless communicator circuitry to maintain use of the second communication protocol in a case where the electronic controller circuitry does not receive, via the wireless communicator circuitry, the first signal including the first information indicative of the first communication protocol.

With the human-powered vehicle component according to the first aspect, the electronic controller circuitry enables the human-powered vehicle component to establish wireless connection with the additional human-powered vehicle component in a case where the additional human-powered vehicle component is compatible with the first communication protocol and where the additional human-powered vehicle component is not compatible with the first communication protocol. Thus, it is possible to improve the usability of the human-powered vehicle component.

In accordance with a second aspect of the present invention, the human-powered vehicle component according to the first aspect is configured so that the electronic controller circuitry is configured to control the wireless communicator circuitry to use the second communication protocol before receipt of the first signal in a paired state where the human-powered vehicle component is paired with the additional human-powered vehicle component. The electronic controller circuitry is configured to change the communication protocol of the wireless communicator circuitry from the second communication protocol to the first communication protocol based on the first signal in a case where the first signal includes the first information indicative of the first communication protocol in a paired state where the human-powered vehicle component is paired with the additional human-powered vehicle component.

With the human-powered vehicle component according to the second aspect, it is possible to change the communication protocol in the paired state where the human-powered vehicle component is paired with the additional human-powered vehicle component, namely in a state where the wireless connection is established between the human-powered vehicle component and the additional human-powered vehicle component. Thus, it is possible to further improve the usability of the human-powered vehicle component.

In accordance with a third aspect of the present invention, the human-powered vehicle component according to the first or second aspect is configured so that the electronic controller circuitry is configured to control the wireless communicator circuitry to use the second communication protocol in a pairing process regardless of whether the additional human-powered vehicle component is configured to use the first communication protocol.

With the human-powered vehicle component according to the third aspect, the electronic controller circuitry enables the human-powered vehicle component to reliably establish wireless connection with the additional human-powered vehicle component using the second communication protocol.

In accordance with a fourth aspect of the present invention, the human-powered vehicle component according to any one of the first to third aspects is configured so that the additional human-powered vehicle component includes a first additional human-powered vehicle component and a second additional human-powered vehicle component. The wireless communicator circuitry is configured to communicate wirelessly with first additional wireless communicator circuitry of the first additional human-powered vehicle component and second additional wireless communicator circuitry of the second additional human-powered vehicle component. The first additional wireless communicator circuitry is configured to use the first communication protocol. The second additional wireless communicator circuitry is configured to use the second communication protocol. The electronic controller circuitry is configured to cause the human-powered vehicle component to be in a paired state where the human-powered vehicle component is paired with both the first additional human-powered vehicle component and the second additional human-powered vehicle component.

With the human-powered vehicle component according to the fourth aspect, the electronic controller circuitry enables the human-powered vehicle component to establish wireless connection with the first additional human-powered vehicle component and the second additional human-powered vehicle component. This allows the human-powered vehicle component to communicate with each of the first additional human-powered vehicle component and the second additional human-powered vehicle component which have different communication protocols. Thus, it is possible to further improve the usability of the human-powered vehicle component.

In accordance with a fifth aspect of the present invention, a human-powered vehicle component comprises wireless communicator circuitry and electronic controller circuitry. The wireless communicator circuitry is configured to communicate wirelessly with first additional wireless communicator circuitry of a first additional human-powered vehicle component and second additional wireless communicator circuitry of a second additional human-powered vehicle component. The first additional wireless communicator circuitry is configured to use a first communication protocol. The second additional wireless communicator circuitry is configured to use a second communication protocol. Each of the first additional human-powered vehicle component and the second additional human-powered vehicle component has only a function relating to a human-powered vehicle. The electronic controller circuitry is electrically connected to the wireless communicator circuitry and is configured to receive a first signal from at least one of the first additional wireless communicator circuitry and the second additional wireless communicator circuitry via the wireless communicator circuitry. The electronic controller circuitry is configured to cause the human-powered vehicle component to be in a paired state where the human-powered vehicle component is paired with both the first additional human-powered vehicle component and the second additional human-powered vehicle component.

With the human-powered vehicle component according to the fifth aspect, the electronic controller circuitry enables the human-powered vehicle component to establish wireless connection with the first additional human-powered vehicle component and the second additional human-powered vehicle component. This allows the human-powered vehicle component to communicate with each of the first additional human-powered vehicle component and the second additional human-powered vehicle component which have different communication protocols. Thus, it is possible to improve the usability of the human-powered vehicle component.

In accordance with a sixth aspect of the present invention, the human-powered vehicle component according to the fourth or fifth aspect is configured so that the human-powered vehicle component is configured to be operated based on each of: a first user input received by the first additional human-powered vehicle component; and a second user input received by the second additional human-powered vehicle component. The electronic controller circuitry is configured to receive a first control signal indicative of the first user input from the first additional wireless communicator circuitry using the first communication protocol. The electronic controller circuitry is configured to receive a second control signal indicative of the second user input from the second additional wireless communicator circuitry using the second communication protocol.

With the human-powered vehicle component according to the sixth aspect, it is possible to further improve the usability of the human-powered vehicle component using the first user input and the second user input.

In accordance with a seventh aspect of the present invention, the human-powered vehicle component according to the fourth or fifth aspect further comprises an operating device configured to receive: a first user input to operate the first additional human-powered vehicle component; and a second user input to operate the second additional human-powered vehicle component. The electronic controller circuitry is configured to transmit a first control signal indicative of the first user input via the wireless communicator circuitry using the first communication protocol. The electronic controller circuitry is configured to transmit a second control signal indicative of the second user input via the wireless communicator circuitry using the second communication protocol.

With the human-powered vehicle component according to the seventh aspect, it is possible to further improve the usability of the human-powered vehicle component using the first user input and the second user input.

In accordance with an eighth aspect of the present invention, the human-powered vehicle component according to any one of the first to seventh aspects is configured so that the electronic controller circuitry is configured to transmit wirelessly, via the wireless communicator circuitry, a second signal including second information indicative of the first communication protocol.

With the human-powered vehicle component according to the eighth aspect, the electronic controller circuitry enables the additional human-powered vehicle component to recognize that the human-powered vehicle component is compatible with the first communication protocol. Thus, it is possible to further improve the usability of the human-powered vehicle component.

In accordance with a ninth aspect of the present invention, the human-powered vehicle component according to the eighth aspect is configured so that the electronic controller circuitry is configured to wirelessly receive, via the wireless communicator circuitry, the first signal transmitted using the second communication protocol. The first signal includes the first information indicative of the first communication protocol. The electronic controller circuitry is configured to wirelessly transmit the second signal using the first communication protocol via the wireless communicator circuitry. The second signal includes second information indicative of the first communication protocol.

With the human-powered vehicle component according to the ninth aspect, it is possible to further improve the usability of the human-powered vehicle component.

In accordance with a tenth aspect of the present invention, the human-powered vehicle component according to the ninth aspect is configured so that the additional human-powered vehicle is configured to wirelessly transmit the first signal in response to an additional user input received by an additional user interface of the additional human-powered vehicle.

With the human-powered vehicle component according to the tenth aspect, it is possible to transmit the first signal manually using the additional user interface of the additional human-powered vehicle. Thus, it is possible to reliably improve the usability of the human-powered vehicle component.

In accordance with an eleventh aspect of the present invention, the human-powered vehicle component according to the tenth aspect is configured so that the additional user interface is configured to receive an additional user gear-change input.

With the human-powered vehicle component according to the eleventh aspect, it is possible to utilize the additional user gear-change input to transmit the first signal. Thus, it is possible to reliably improve the usability of the human-powered vehicle component.

In accordance with a twelfth aspect of the present invention, the human-powered vehicle component according to any one of the eighth to eleventh aspects is configured so that the electronic controller circuitry is configured to wirelessly transmit the second signal using the second communication protocol via the wireless communicator circuitry.

With the human-powered vehicle component according to the twelfth aspect, it is possible to further improve the usability of the human-powered vehicle component.

In accordance with a thirteenth aspect of the present invention, the human-powered vehicle component according to any one of the eighth to twelfth aspects further comprises a user interface configured to receive a user input. The electronic controller circuitry is configured to transmit the second signal wirelessly via the wireless communicator circuitry in response to the user input received by the user interface.

With the human-powered vehicle component according to the thirteenth aspect, it is possible to further improve the usability of the human-powered vehicle component using the user interface.

In accordance with a fourteenth aspect of the present invention, the human-powered vehicle component according to the thirteenth aspect is configured so that the user interface is configured to receive a user gear-change input. The electronic controller circuitry is configured to transmit the first signal wirelessly via the wireless communicator circuitry in response to the user gear-change input received by the user interface.

With the human-powered vehicle component according to the fourteenth aspect, it is possible to utilize the user gear-change input to transmit the first signal. Thus, it is possible to reliably improve the usability of the human-powered vehicle component.

In accordance with a fifteenth aspect of the present invention, the human-powered vehicle component according to any one of the first to fourteenth aspects is configured so that the electronic controller circuitry is configured to transmit an acknowledgement signal via the wireless communicator circuitry in response to the first signal regardless of whether the first signal includes first information indicative of the first communication protocol or the second communication protocol.

With the human-powered vehicle component according to the fifteenth aspect, it is possible to reliably maintain wireless connection between the human-powered vehicle component and the additional human-powered vehicle component using the acknowledgement signal.

In accordance with a sixteenth aspect of the present invention, the human-powered vehicle component according to any one of the first to fifteenth aspects is configured so that the electronic controller circuitry is configured to maintain use of the second communication protocol based on the first signal in a case where the first signal includes first information indicative of the second communication protocol.

With the human-powered vehicle component according to the sixteenth aspect, it is possible to further improve the usability of the human-powered vehicle component.

In accordance with a seventeenth aspect of the present invention, the human-powered vehicle component according to any one of the first to sixteenth aspects is configured so that the electronic controller circuitry is configured to transmit or receive a control signal via the wireless communicator circuitry using the first communication protocol after the electronic controller circuitry changes the communication protocol from the second communication protocol to the first communication protocol. The electronic controller circuitry is configured to transmit or receive a control signal via the wireless communicator circuitry using the second communication protocol in a case where the electronic controller circuitry maintains use of the second communication protocol.

With the human-powered vehicle component according to the seventeenth aspect, it is possible to control one of the human-powered vehicle component and the additional human-powered vehicle component using the other of the human-powered vehicle component and the additional human-powered vehicle component.

In accordance with an eighteenth aspect of the present invention, the human-powered vehicle component according to any one of the first to seventeenth aspects is configured so that a version of the first communication protocol is newer than a version of the second communication protocol.

With the human-powered vehicle component according to the eighteenth aspect, it is possible to use the second communication protocol having the version which is older than the version of the first communication protocol in a case where the additional human-powered vehicle component is not compatible with the first communication protocol. Thus, it is possible to reliably improve the usability of the human-powered vehicle component.

In accordance with a nineteenth aspect of the present invention, a human-powered vehicle system comprises the human-powered vehicle component according to any one of the first to eighteenth aspects and the additional human-powered vehicle component.

With the human-powered vehicle system according to the nineteenth aspect, the human-powered vehicle component can improve the usability of the human-powered vehicle system.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a side elevational view of a human-powered vehicle including a human-powered vehicle system including at least two human-powered vehicle components in accordance with one of embodiments.

FIG. 2 is a side elevational view of one of the at least two human-powered vehicle components illustrated in FIG. 1.

FIG. 3 is a side elevational view of another of the at least two human-powered vehicle components illustrated in FIG. 1.

FIG. 4 is a side elevational view of another of the at least two human-powered vehicle components illustrated in FIG. 1.

FIG. 5 is a side elevational view of another of the at least two human-powered vehicle components illustrated in FIG. 1.

FIG. 6 is a side elevational view of another of the at least two human-powered vehicle components illustrated in FIG. 1.

FIG. 7 is a side elevational view of another of the at least two human-powered vehicle components illustrated in FIG. 1.

FIG. 8 is a side elevational view of another of the at least two human-powered vehicle components illustrated in FIG. 1.

FIG. 9 is a schematic block diagram of the human-powered vehicle system illustrated in FIG. 1.

FIG. 10 is a schematic diagram showing signals transmitted between the at least two human-powered vehicle components.

FIG. 11 is another schematic block diagram of the human-powered vehicle system illustrated in FIG. 1.

FIG. 12 is another schematic diagram showing signals transmitted between the at least two human-powered vehicle components.

FIG. 13 is another schematic diagram showing signals transmitted between the at least two human-powered vehicle components.

FIG. 14 is another schematic block diagram of the human-powered vehicle system illustrated in FIG. 1.

FIGS. 15 to 17 are flowcharts of a control executed in one of the at least two human-powered vehicle components of the human-powered vehicle system illustrated in FIG. 1.

FIGS. 18 to 20 are flowcharts of a control executed in another of the at least two human-powered vehicle components of the human-powered vehicle system illustrated in FIG. 1.

FIG. 21 is a schematic block diagram of a human-powered vehicle system in accordance with a first modification.

FIG. 22 is a schematic diagram showing signals transmitted between the at least two human-powered vehicle components of the human-powered vehicle system illustrated in FIG. 21.

FIG. 23 is a schematic block diagram of a human-powered vehicle system in accordance with a second modification.

FIG. 24 is a schematic block diagram of a human-powered vehicle system in accordance with a third modification.

FIG. 25 is a schematic block diagram of a human-powered vehicle system in accordance with a fourth modification.

### DESCRIPTION OF THE EMBODIMENTS

The embodiments will now be described with reference to the accompanying drawings, wherein like reference numerals designate corresponding or identical elements throughout the various drawings.

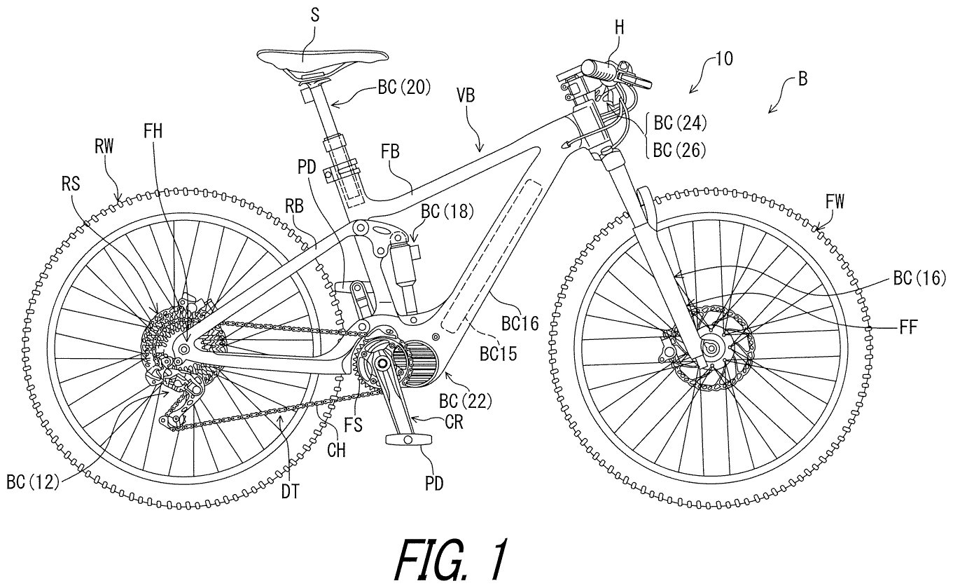

Referring initially to FIG. 1, a human-powered vehicle B includes a human-powered vehicle system 10 in accordance with one of embodiments. The human-powered vehicle system 10 includes at least one human-powered vehicle component BC. In the present embodiment, the human-powered vehicle B is illustrated as an e-bike that uses a driving force of an electric motor in addition to a human driving force for propulsion. However, the human-powered vehicle system 10 can be applied to any other type of human-powered vehicles such as, for example, a mountain bike, a cyclocross bicycle, a gravel bike, a city bike, a cargo bike, and a recumbent bike.

In the present application, the term “human-powered vehicle” includes a vehicle to travel with a motive power including at least a human power of a user who rides the vehicle. The human-powered vehicle includes a various kind of bicycles such as a mountain bike, a road bike, a city bike, a cargo bike, a hand bike, and a recumbent bike. Furthermore, the human-powered vehicle includes an electric bike called as an E-bike. The electric bike includes an electrically assisted bicycle configured to assist propulsion of a vehicle with an electric motor. However, a total number of wheels of the human-powered vehicle is not limited to two. For example, the human-powered vehicle includes a vehicle having one wheel or three or more wheels. Especially, the human-powered vehicle does not include a vehicle that uses only a driving source as motive power. Examples of the driving source include an internal-combustion engine and an electric motor. Generally, a light road vehicle, which includes a vehicle that does not require a driver's license for a public road, is assumed as the human-powered vehicle.

Basically, the human-powered vehicle system 10 is directed to pairing at least two devices such that the at least two devices can wirelessly communicate with each other. Thus, the term “human-powered vehicle component” as used herein generically refers to all the human-powered vehicle components BC of the human-powered vehicle B that are configured to wirelessly communicate with another one of the human-powered vehicle components BC of the human-powered vehicle B after being paired together. The components or parts of the human-powered vehicle B that cannot wirelessly communicate will not be referred to as “human-powered vehicle component” herein.

As seen in FIG. 1, the human-powered vehicle B includes a vehicle body VB, a wheel FW, and a wheel RW. The wheel FW is rotatably coupled to the vehicle body VB. The wheel RW is rotatably coupled to the vehicle body VB. The vehicle body VB is supported by the wheels FW and RW. The wheel FW can also be referred to as a front wheel FW. The wheel RW can also be referred to as a rear wheel RW.

The vehicle body VB includes a front frame body FB, a rear frame body RB, a handlebar H, and a front fork FF. The rear frame body RB includes a swing arm. The rear frame body RB is movably coupled to the front frame body FB. The rear frame body RB is pivotally coupled to the front frame body FB. The front fork FF is pivotally coupled to the front frame body FB. The handlebar H is coupled to the front fork FF to be pivotable relative to the front frame body FB along with the front fork FF.

The human-powered vehicle B further includes a drivetrain DT. Here, for example, the drivetrain DT is a chain-drive type and includes a crank CR, at least one front sprocket FS, at least two rear sprockets RS, a chain CH, and pedals PD. The crank CR is rotatably coupled to the vehicle body VB. The at least one front sprocket FS is coupled to the crank CR to rotate relative to the vehicle body VB along with the crank CR. The at least two rear sprockets RS are provided on a hub assembly FH of the wheel RW. The chain CH is configured to be engaged with one of the at least one front sprocket FS and one of the at least two rear sprockets RS. The pedals PD are coupled to the crank CR. A human driving force is applied to the pedals PD by a rider such that the driving force is transmitted to the wheel RW via the at least one front sprocket FS, the chain CH, and the at least two rear sprockets RS. While the drivetrain DT is illustrated as a chain-drive type of drivetrain, the drivetrain DT can be selected from any type of drivetrain and can be a belt-drive type or a shaft-drive type.

In the present application, the following directional terms “front,” “rear,” “forward,” “rearward,” “left,” “right,” “transverse,” “upward” and “downward” as well as any other similar directional terms refer to those directions which are determined based on the user who is in the user's standard position in the human-powered vehicle B while the user faces toward a handlebar or steering. Examples of the user's standard position include a saddle and a seat. Accordingly, these terms, as utilized to describe the human-powered vehicle system 10, the human-powered vehicle component BC, or other components, should be interpreted relative to the human-powered vehicle B equipped with the human-powered vehicle system 10, the human-powered vehicle component BC, or other components as used in an upright riding position on a horizontal surface.

As seen in FIG. 1, the at least one human-powered vehicle component BC includes a gear changer 12, a suspension 16, a suspension 18, an adjustable seatpost 20, and an assist drive unit 22. Namely, the human-powered vehicle system 10 includes the gear changer 12, the suspension 16, the suspension 18, the adjustable seatpost 20, and the assist drive unit 22. The gear changer 12 is configured to be mounted to the vehicle body VB. The suspension 16 is configured to be mounted to the vehicle body VB. The suspension 18 is configured to be mounted to the vehicle body VB. The adjustable seatpost 20 is configured to be mounted to the vehicle body VB. The assist drive unit 22 is configured to be mounted to the vehicle body VB.

As seen in FIG. 1, the gear changer 12 is configured to change a gear ratio of the human-powered vehicle B. The gear ratio is a ratio of a rotational speed of the at least two rear sprockets RS to a rotational speed of the at least one front sprocket FS. The gear changer 12 has at least two gear stages having at least two gear ratios, respectively. The gear changer 12 is configured to change the current gear ratio among the at least two gear ratios. The gear changer 12 is configured to change a current gear stage among the at least two gear stages. For example, the gear changer 12 is configured to shift the chain CH relative to the at least two rear sprockets RS. In the present embodiment, the gear changer 12 includes a rear derailleur. However, the gear changer 12 can include another type of gear changer 12 if needed or desired. Examples of another type of gear changer 12 include a front derailleur and an internal-gear hub.

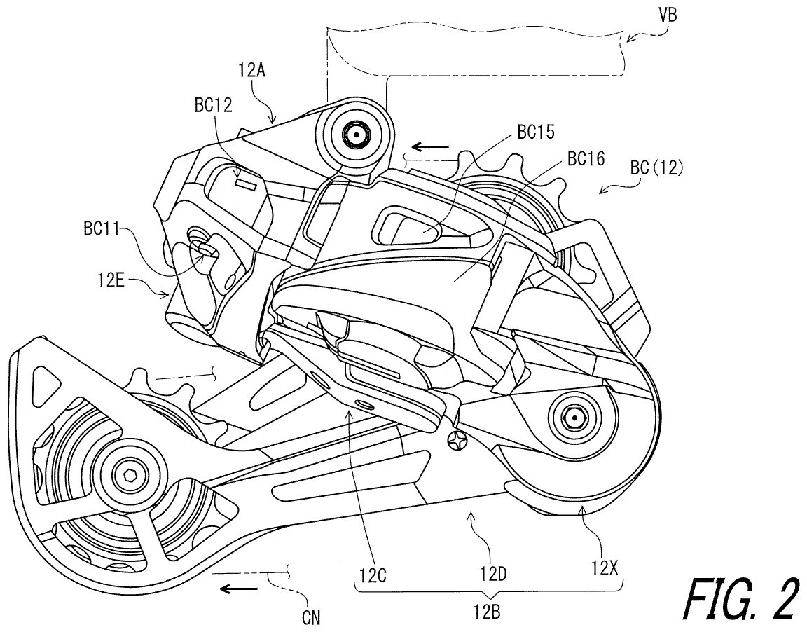

As seen in FIG. 2, the gear changer 12 further comprises a base member 12A and a movable structure 12B. The base member 12A is mountable to the vehicle body VB. The movable structure 12B is movable relative to the base member 12A. For example, the movable structure 12B includes a linkage 12C, a chain guide 12D, and a movable member 12X. The chain guide 12D is contactable with the chain CH. The linkage 12C movably couples the base member 12A and the movable member 12X. The chain guide 12D is pivotally coupled to the movable member 12X.

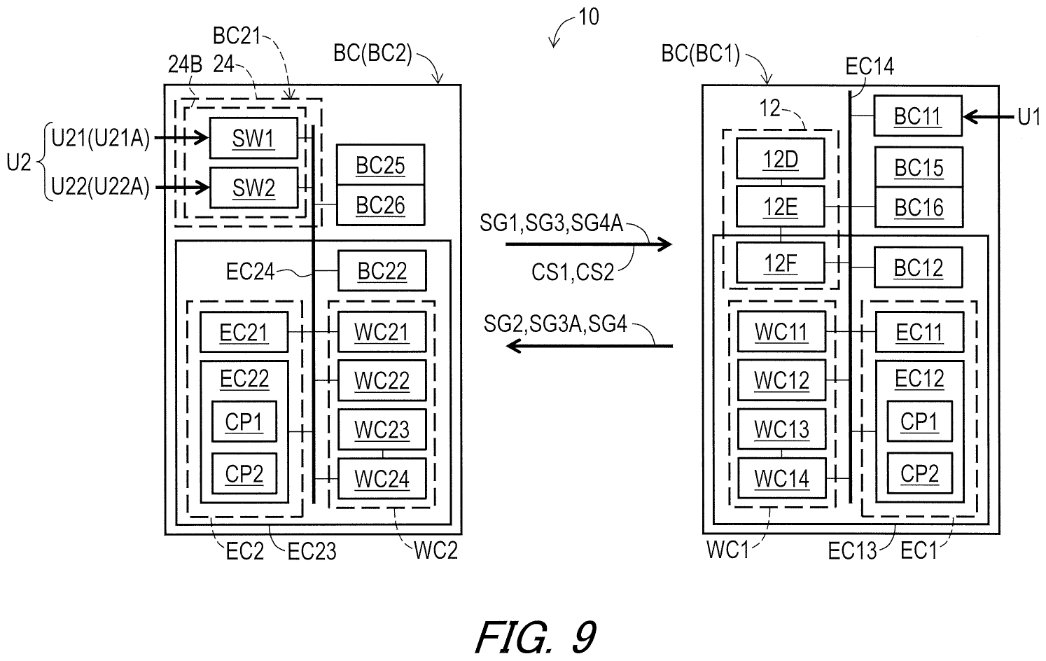

The gear changer 12 comprises an electric actuator 12E. The electric actuator 12E is configured to generate an actuation force. Examples of the electric actuator 12E include an electric motor. The electric actuator 12E is coupled to at least one of the base member 12A and the movable structure 12B to move the movable structure 12B relative to the base member 12A. The electric actuator 12E is at least partially provided to at least one of the base member 12A, the movable structure 12B, the linkage 12C, the chain guide 12D, and the movable member 12X. The gear changer 12 includes an actuator driver 12F (see e.g., FIG. 9) electrically connected to the electric actuator 12E to control the electric actuator 12E. The electric actuator 12E can be configured to be controlled based on a control signal transmitted from another device or to be automatically controlled based on information relating to the human-powered vehicle B.

As seen in FIG. 1, the suspension 16 is configured to absorb or damp shocks or vibrations generated by riding on rough terrain. The suspension 16 is installed in the front fork FF. The suspension 16 and the front fork FF constitute a suspension fork. The suspension 16 is configured to absorb or damp shocks or vibrations transmitted from at least one of the wheels FW and RW.

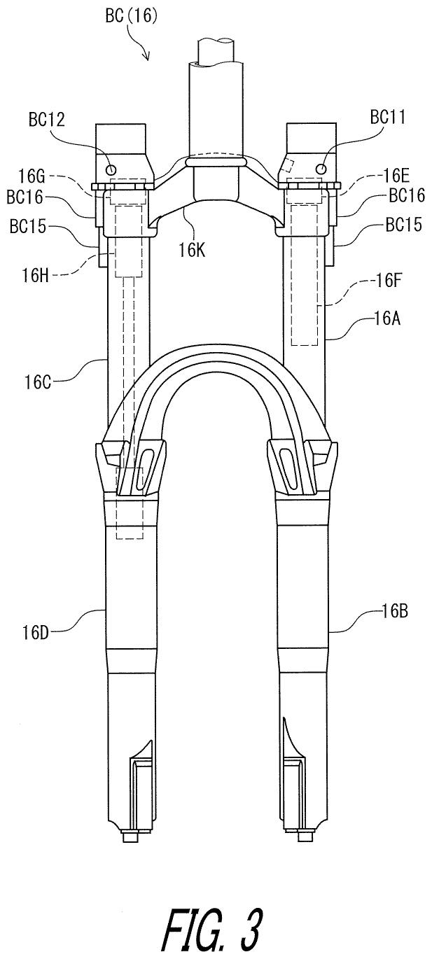

As seen in FIG. 3, the suspension 16 includes a first longitudinal member 16A and a second longitudinal member 16B. The first longitudinal member 16A and the second longitudinal member 16B are relatively movable. The suspension 16 includes a crown 16K. The first longitudinal member 16A is coupled to the crown 16K. The wheel FW is rotatably coupled to the second longitudinal member 16B. For example, the first longitudinal member 16A and the second longitudinal member 16B define a fluid chamber filled with a fluid such as oil.

The suspension 16 includes a third longitudinal member 16C and a fourth longitudinal member 16D. The third longitudinal member 16C and the fourth longitudinal member 16D are relatively movable. The third longitudinal member 16C is coupled to the crown 16K. The wheel FW is rotatably coupled to the fourth longitudinal member 16D. For example, the third longitudinal member 16C and the fourth longitudinal member 16D define an air chamber filled with air.

The suspension 16 comprises an electric actuator 16E. The electric actuator 16E is configured to generate an actuation force. Examples of the electric actuator 16E include an electric motor. The suspension 16 includes an actuator driver electrically connected to the electric actuator 16E to control the electric actuator 16E.

The suspension 16 includes a state changing structure 16F configured to change the state of the suspension 16 between a first state and a second state. The electric actuator 16E is configured to actuate the state changing structure 16F to change the state of the suspension 16 between the first state and the second state. For example, the state changing structure 16F includes a valve unit. The electric actuator 16E is coupled to the state changing structure 16F. The electric actuator 16E is configured to actuate the state changing structure 16F to change the state of the suspension 16 between the first state and the second state.

For example, the state changing structure 16F is configured to allow the first longitudinal member 16A and the second longitudinal member 16B to relatively move under a first damping property in the first state. The state changing structure 16F is configured to allow the first longitudinal member 16A and the second longitudinal member 16B to relatively move under a second damping property in the second state. The second damping property is different from the first damping property.

The suspension 16 comprises an electric actuator 16G. The electric actuator 16G is configured to generate an actuation force. Examples of the electric actuator 16G include an electric motor. The suspension 16 includes an actuator driver electrically connected to the electric actuator 16G to control the electric actuator 16G.

The suspension 16 includes a state changing structure 16H configured to change the state of the suspension 16 between a third state and a fourth state. The electric actuator 16E is configured to actuate the state changing structure 16H to change the state of the suspension 16 between the third state and the fourth state. For example, the state changing structure 16H includes a valve unit. The electric actuator 16G is coupled to the state changing structure 16H. The electric actuator 16G is configured to actuate the state changing structure 16H to change the state of the suspension 16 between the first state and the second state.

For example, the state changing structure 16H is configured to allow the third longitudinal member 16C and the fourth longitudinal member 16D to relatively move within a first stroke in the third state. The state changing structure 16H is configured to allow the third longitudinal member 16C and the fourth longitudinal member 16D to relatively move within a second stroke in the fourth state. The second stroke is different from the first stroke. One of the first stroke and the second stroke can be zero.

In the present embodiment, the suspension 16 includes the electric actuator 16E, the state changing structure 16F, the electric actuator 16G, and the state changing structure 16H. However, the electric actuator 16E and the state changing structure 16F can be omitted from the suspension 16 if needed or desired. The electric actuator 16G and the state changing structure 16H can be omitted from the suspension 16 if needed or desired. Furthermore, the suspension 16 can include another type of a state changing structure other than the state changing structures 16F and 16H if needed or desired.

As seen in FIG. 1, the suspension 18 is configured to absorb or damp shocks or vibrations generated by riding on rough terrain. The suspension 18 is coupled to the front frame body FB and the rear frame body RB. The suspension 18 is configured to absorb or damp shocks or vibrations transmitted from at least one of the wheels FW and RW.

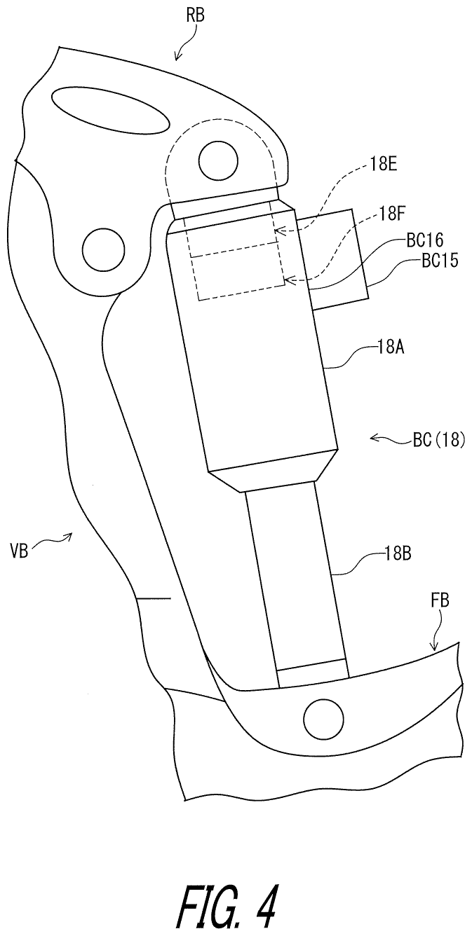

As seen in FIG. 4, the suspension 18 includes a first longitudinal member 18A and a second longitudinal member 18B. The first longitudinal member 18A and the second longitudinal member 18B are relatively movable. The first longitudinal member 18A and the second longitudinal member 18B define an air chamber or a fluid chamber. The first longitudinal member 18A is pivotally coupled to the rear frame body RB. The second longitudinal member 18B is pivotally coupled to the front frame body FB.

The suspension 18 comprises an electric actuator 18E. The electric actuator 18E is configured to generate an actuation force. Examples of the electric actuator 18E include an electric motor. The suspension 18 includes an actuator driver electrically connected to the electric actuator 18E to control the electric actuator 18E.

The suspension 18 includes a state changing structure 18F configured to change the state of the suspension 18 between a first state and a second state. The electric actuator 18E is configured to actuate the state changing structure 18F to change the state of the suspension 18 between the first state and the second state. For example, the state changing structure 18F includes a valve unit. The electric actuator 18E is coupled to the state changing structure 18F. The electric actuator 18E is configured to actuate the state changing structure 18F to change the state of the suspension 18 between the first state and the second state.

The state changing structure 18F is configured to allow the first longitudinal member 18A and the second longitudinal member 18B to relatively move within a first stroke or under a first damping property in the first state. The state changing structure 18F is configured to allow the first longitudinal member 18A and the second longitudinal member 18B to relatively move within a second stroke or under a second damping property in the second state.

As seen in FIG. 1, the adjustable seatpost 20 is configured to change a height of the saddle S relative to the vehicle body VB. The adjustable seatpost 20 has an adjustable state and a locked state. The adjustable seatpost 20 allows the user to change the height of the saddle S in the adjustable state. The adjustable seatpost 20 is locked to maintain the height of the saddle S in the locked state. The adjustable seatpost 20 is configured to change the state of the adjustable seatpost 20 between the adjustable state and the locked state.

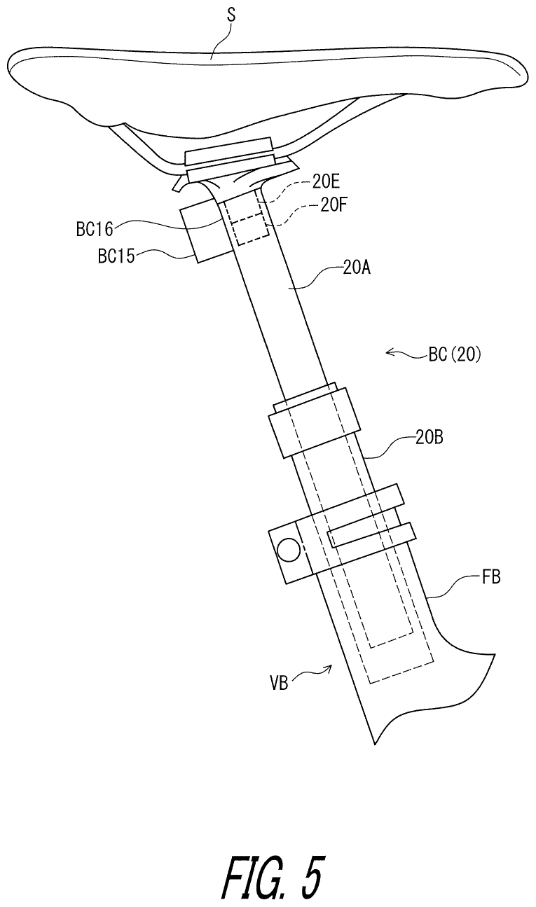

As seen in FIG. 5, the adjustable seatpost 20 includes a first longitudinal member 20A and a second longitudinal member 20B. The first longitudinal member 20A and the second longitudinal member 20B are relatively movable. The saddle S is coupled to the first longitudinal member 20A. The second longitudinal member 20B is coupled to the vehicle body VB.

The adjustable seatpost 20 comprises an electric actuator 20E. The electric actuator 20E is configured to generate an actuation force. Examples of the electric actuator 20E include an electric motor. The adjustable seatpost 20 includes an actuator driver electrically connected to the electric actuator 20E to control the electric actuator 20E.

The adjustable seatpost 20 includes a state changing structure 20F configured to change the state of the adjustable seatpost 20 between the adjustable state and the locked state. The electric actuator 20E is configured to actuate the state changing structure 20F to change the state of the adjustable seatpost 20 between the adjustable state and the locked state. For example, the state changing structure 20F includes a valve unit. The electric actuator 20E is coupled to the state changing structure 20F. The electric actuator 20E is configured to actuate the state changing structure 20F to change the state of the adjustable seatpost 20 between the adjustable state and the locked state.

The state changing structure 20F is configured to allow the first longitudinal member 20A and the second longitudinal member 20B to relatively move in the adjustable state. The state changing structure 20F is configured to restrict the first longitudinal member 20A and the second longitudinal member 20B from relatively moving in the locked state.

As seen in FIG. 1, the assist drive unit 22 is configured to assist propulsion of the human-powered vehicle B. The assist drive unit 22 is configured to change an assist ratio depending on a human power applied to the human-powered vehicle B. For example, the assist drive unit 22 is configured to change the assist ratio depending on pedaling torque applied to the crank CR.

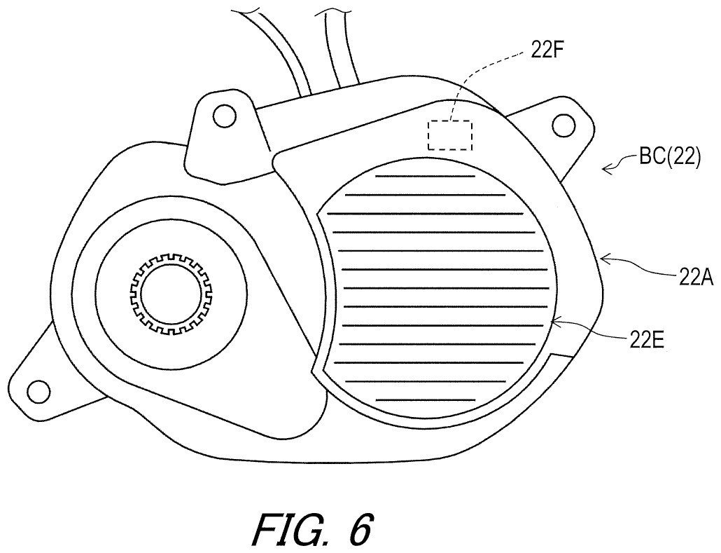

As seen in FIG. 6, the assist drive unit 22 comprises a housing 22A, an electric actuator 22E, and an actuator driver 22F. The electric actuator 22E is at least partially provided in the housing 22A. The electric actuator 22E is configured to generate an actuation force. The actuator driver 22F is electrically connected to the electric actuator 22E to control the electric actuator 22E. Examples of the electric actuator 22E include an electric motor. The assist drive unit 22 includes an actuator driver electrically connected to the electric actuator 22E to control the electric actuator 22E. The electric actuator 22E is configured to apply the actuation force to the human-powered vehicle B to assist propulsion of the human-powered vehicle B.

As seen in FIG. 1, the at least one human-powered vehicle component BC includes an operating device 24 and an operating device 26. The operating device 24 is configured to be mounted to the handlebar H. The operating device 24 is configured to receive a user input. The operating device 24 is configured to operate at least one of the at least one human-powered vehicle component BC in response to the user input. The operating device 26 is configured to be mounted to the handlebar H. The operating device 26 is configured to receive an additional user input. The operating device 26 is configured to operate at least one of the at least one human-powered vehicle component BC in response to the additional user input.

The operating device 24 is configured to operate at least one of the gear changer 12, the suspension 16, the suspension 18, the adjustable seatpost 20, and the assist drive unit 22 in response to the user input. The operating device 26 is configured to operate at least one of the gear changer 12, the suspension 16, the suspension 18, the adjustable seatpost 20, and the assist drive unit 22 in response to the additional user input. The at least one human-powered vehicle component BC can include another operating device other than the operating device 24 and the operating device 26 if needed or desired.

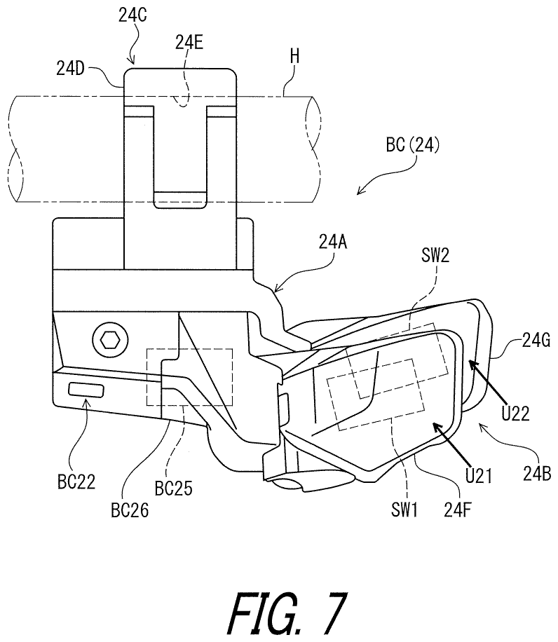

As seen in FIG. 7, the operating device 24 includes a housing 24A, a user interface 24B, and a mounting portion 24C. The housing 24A is configured to be mounted to the vehicle body VB of the human-powered vehicle B. The user interface 24B is configured to be operated by the user to control at least one of the at least one human-powered vehicle component BC while the human-powered vehicle B is running. The mounting portion 24C is configured to couple the housing 24A and the vehicle body VB. The mounting portion 24C is configured to couple the housing 24A and the handlebar H of the vehicle body VB. For example, the mounting portion 24C includes a clamp 24D and a clamp fastener. The clamp 24D includes a clamp opening 24E through which the handlebar H is to extend. The clamp fastener is configured to fasten the clamp 24D to the handlebar H.

The user interface 24B is configured to receive a user input U21. For example, the user interface 24B includes a switch SW1 configured to be activated in response to the user input U21.

The user interface 24B includes a user operating member 24F. The user operating member 24F is movably coupled to the housing 24A. The user operating member 24F is movable relative to the housing 24A in response to the user input U21. The user operating member 24F is configured to transmit the motion of the user operating member 24F to the switch SW1. The user input U21 can be referred to as an additional user input U21.

The user interface 24B is configured to receive a user input U22. For example, the user interface 24B includes a switch SW2 configured to be activated in response to the user input U22.

The user interface 24B includes a user operating member 24G. The user operating member 24G is movably coupled to the housing 24A. The user operating member 24G is movable relative to the housing 24A in response to the user input U22. The user operating member 24G is configured to transmit the motion of the user operating member 24G to the switch SW2. The user input U22 can be referred to as an additional user input U22.

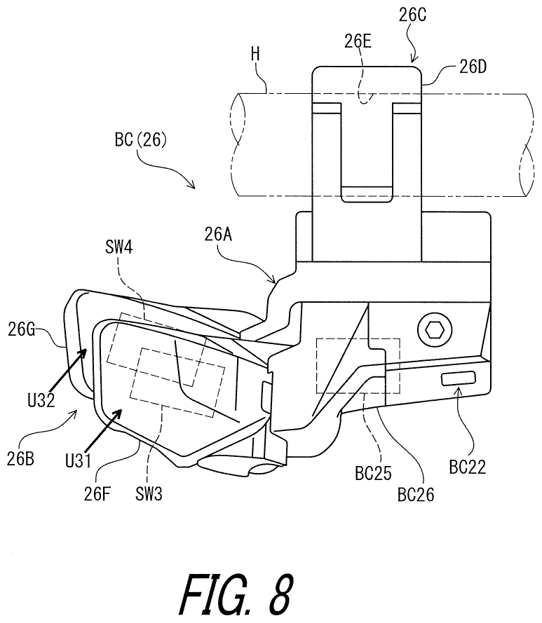

As seen in FIG. 8, the operating device 26 includes a housing 26A, a user interface 26B, and a mounting portion 26C. The housing 26A is configured to be mounted to the vehicle body VB of the human-powered vehicle B. The user interface 26B is configured to be operated by the user to control at least one of the at least one human-powered vehicle component BC while the human-powered vehicle B is running. The mounting portion 26C is configured to couple the housing 26A and the vehicle body VB. The mounting portion 26C is configured to couple the housing 26A and the handlebar H of the vehicle body VB. For example, the mounting portion 26C includes a clamp 26D and a clamp fastener. The clamp 26D includes a clamp opening 26E through which the handlebar H is to extend. The clamp fastener is configured to fasten the clamp 26D to the handlebar H.

The user interface 26B is configured to receive a user input U31. For example, the user interface 26B includes a switch SW3 configured to be activated in response to the user input U31.

The user interface 26B includes a user operating member 26F. The user operating member 26F is movably coupled to the housing 26A. The user operating member 26F is movable relative to the housing 26A in response to the user input U31. The user operating member 26F is configured to transmit the motion of the user operating member 26F to the switch SW3. The user input U31 can be referred to as an additional user input U31.

The user interface 26B is configured to receive a user input U32. For example, the user interface 26B includes a switch SW4 configured to be activated in response to the user input U32.

The user interface 26B includes a user operating member 26G. The user operating member 26G is movably coupled to the housing 26A. The user operating member 26G is movable relative to the housing 26A in response to the user input U32. The user operating member 26G is configured to transmit the motion of the user operating member 26G to the switch SW4. The user input U32 can be referred to as an additional user input U32.

As seen in FIG. 9, the at least one human-powered vehicle component BC includes a human-powered vehicle component BC1 and an additional human-powered vehicle component BC2. Namely, the human-powered vehicle system 10 comprises the human-powered vehicle component BC1 and the additional human-powered vehicle component BC2. The human-powered vehicle component BC1 can be referred to as an additional human-powered vehicle component BC1 in a case where the additional human-powered vehicle component BC2 can be referred to as a human-powered vehicle component BC2.

The human-powered vehicle component BC1 includes one of the gear changer 12, the suspension 16, the suspension 18, the adjustable seatpost 20, the assist drive unit 22, the operating device 24, and the operating device 26. The additional human-powered vehicle component BC2 includes the other of the gear changer 12, the suspension 16, the suspension 18, the adjustable seatpost 20, the assist drive unit 22, the operating device 24, and the operating device 26.

In the present embodiment, the human-powered vehicle component BC1 includes the gear changer 12. The additional human-powered vehicle component BC2 includes the operating device 24. However, the human-powered vehicle component BC1 is not limited to the gear changer 12. The additional human-powered vehicle component BC2 is not limited to the operating device 24. The human-powered vehicle component BC1 can include a device other than the gear changer 12 if needed or desired. The additional human-powered vehicle component BC2 can include a device other than the operating device 24 if needed or desired. The additional human-powered vehicle component BC2 can include both the operating devices 24 and 26.

For example, the human-powered vehicle component BC1 can include the suspension 16 or 18 while the additional human-powered vehicle component BC2 can include the operating device 24 or 26. The human-powered vehicle component BC1 can include the assist drive unit 22 while the additional human-powered vehicle component BC2 can include the gear changer 12.

In a case where the human-powered vehicle component BC1 includes the gear changer 12, the human-powered vehicle component BC1 includes the electric actuator 12E (see e.g., FIG. 2). In a case where the human-powered vehicle component BC1 includes the suspension 16, the human-powered vehicle component BC1 includes the electric actuator 16E and/or 16G (see e.g., FIG. 3). In a case where the human-powered vehicle component BC1 includes the suspension 18, the human-powered vehicle component BC1 includes the electric actuator 18E (see e.g., FIG. 4). In a case where the human-powered vehicle component BC1 includes the adjustable seatpost 20, the human-powered vehicle component BC1 includes the electric actuator 20E (see e.g., FIG. 5). In a case where the human-powered vehicle component BC1 includes the assist drive unit 22, the human-powered vehicle component BC1 includes the electric actuator 22E (see e.g., FIG. 6).

As seen in FIG. 9, the human-powered vehicle component BC1 further comprises a user interface BC11 configured to receive a user input U1. The electronic controller circuitry EC1 is electrically connected to the user interface BC11 to detect the user input U1 received by the user interface BC11. Examples of the user interface BC11 include a switch. The user input U1 indicates at least one of an on-operation, an off-operation, transmission of a signal, a change in a state of the human-powered vehicle component BC1, and a setting process of a communication protocol of the human-powered vehicle component BC1. The user interface BC11 can be omitted from the human-powered vehicle component BC1 if needed or desired. The user interface BC11 can be referred to as an additional user interface BC11. The user input U1 can be referred to as an additional user input U1.

The human-powered vehicle component BC2 further comprises a user interface BC21 configured to receive a user input U2. In a case where the additional human-powered vehicle component BC2 includes the operating device 24, the user interface BC21 includes the user interface 24B, and the user input U2 includes the user input U21 or U22. The additional human-powered vehicle component BC2 includes the user interface 24B configured to be operated by the user to control the human-powered vehicle component BC1 while the human-powered vehicle B is running. The additional human-powered vehicle component BC2 can include another device other than the operating device 24 if needed or desired. The user interface BC21 can be referred to as an additional user interface BC21. The user input U2 can be referred to as an additional user input U2. The user input U21 can be referred to as an additional user input U21. The user input U22 can be referred to as an additional user input U22.

In the present embodiment, the at least one human-powered vehicle component BC has only a function relating to the human-powered vehicle B. At least one of the human-powered vehicle component BC1 and the additional human-powered vehicle component BC2 has only a function relating to the human-powered vehicle B. Each of the human-powered vehicle component BC1 and the additional human-powered vehicle component BC2 has only the function relating to the human-powered vehicle B. However, at least one of the human-powered vehicle component BC1 and the additional human-powered vehicle component BC2 can has a function other than the function relating to the human-powered vehicle if needed or desired.

The human-powered vehicle component BC1 is configured to establish wireless connection between the human-powered vehicle component BC1 and another human-powered vehicle component such as the additional human-powered vehicle component BC2. The additional human-powered vehicle component BC2 is configured to establish wireless connection between the additional human-powered vehicle component BC2 and another human-powered vehicle component such as the human-powered vehicle component BC1. The human-powered vehicle component BC1 is configured to wirelessly transmit or receive a signal to or from another human-powered vehicle component such as the additional human-powered vehicle component BC2 in a wireless connection state where the wireless connection is established. The additional human-powered vehicle component BC2 is configured to wirelessly transmit or receive a signal to or from another human-powered vehicle component such as the human-powered vehicle component BC1 in the wireless connection state where the wireless connection is established.

As seen in FIG. 9, the human-powered vehicle component BC1 comprises wireless communicator circuitry WC1 and electronic controller circuitry EC1. The additional human-powered vehicle component BC2 comprises additional wireless communicator circuitry WC2 and additional electronic controller circuitry EC2. The wireless communicator circuitry WC1 is configured to communicate wirelessly with the additional wireless communicator circuitry WC2 of the additional human-powered vehicle component BC2. The electronic controller circuitry EC1 is electrically connected to the wireless communicator circuitry WC1. The additional wireless communicator circuitry WC2 is configured to communicate wirelessly with the wireless communicator circuitry WC1 of the human-powered vehicle component BC1. The additional electronic controller circuitry EC2 is electrically connected to the additional wireless communicator circuitry WC2. The wireless communicator circuitry WC1 can be referred to as additional wireless communicator circuitry WC1. The additional wireless communicator circuitry WC2 can be referred to as wireless communicator circuitry WC2. The electronic controller circuitry EC1 can be referred to as additional electronic controller circuitry EC1. The additional electronic controller circuitry EC2 can be referred to as electronic controller circuitry EC2.

The electronic controller circuitry EC1 includes at least one processor EC11 and at least one memory EC12. The electronic controller circuitry EC1 includes at least one circuit board EC13 and at least one system bus EC14. The electronic controller circuitry EC1 is electrically mounted on the at least one circuit board EC13. The at least one processor EC11 and the at least one memory EC12 are electrically mounted on the at least one circuit board EC13. The at least one processor EC11 is coupled to the at least one memory EC12. The at least one memory EC12 is coupled to the at least one processor EC11. The at least one processor EC11 is electrically connected to the at least one memory EC12 via the at least one circuit board EC13 and the at least one system bus EC14. The at least one memory EC12 is electrically connected to the at least one processor EC11 via the at least one circuit board EC13 and the at least one system bus EC14. For example, the electronic controller circuitry EC1 includes at least one semiconductor. The at least one processor EC11 includes at least one semiconductor. The at least one memory EC12 includes at least one semiconductor.

For example, the at least one processor EC11 includes at least one of a central processing unit (CPU), a micro processing unit (MPU), a graphics processing unit (GPU), and a memory controller. The at least one memory EC12 is electrically connected to the at least one processor EC11. For example, the at least one memory EC12 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The at least one memory EC12 includes storage areas each having an address. The at least one processor EC11 is configured to control the at least one memory EC12 to store data in the storage areas of the at least one memory EC12 and reads data from the storage areas of the at least one memory EC12. The at least one processor EC11 can also be referred to as at least one hardware processor EC11, at least one processor circuit EC11, or processor circuitry EC11. The at least one memory EC12 can also be referred to as at least one hardware memory EC12, at least one memory circuit, or memory circuitry EC12. The at least one memory EC12 can also be referred to as a non-transitory computer-readable storage medium EC12. Namely, the electronic controller circuitry EC1 includes the non-transitory computer-readable storage medium EC12.

The electronic controller circuitry EC1 is configured to execute at least one control algorithm of the electronic controller circuitry EC1. For example, the electronic controller circuitry EC1 is programed to execute at least one control algorithm of the electronic controller circuitry EC1. The at least one memory EC12 stores at least one program including at least one computer program code. The at least one program is read into the at least one processor EC11, and thereby the at least one control algorithm of the electronic controller circuitry EC1 is executed based on the at least one program.

The structure of the electronic controller circuitry EC1 is not limited to the above structure. The structure of the electronic controller circuitry EC1 is not limited to the at least one processor EC11 and the at least one memory EC12. The electronic controller circuitry EC1 can be realized by hardware alone or a combination of hardware and software. In the present embodiment, the at least one processor EC11 and the at least one memory EC12 can be separate chips. Alternatively, the at least one processor EC11 and the at least one memory EC12 can be integrated as a single chip such as an application specific integrated circuit (ASIC) or a field programmable gate array (FPGA).

The electronic controller circuitry EC1 can include at least two electronic controller circuits which are separately provided. The at least one control algorithm of the electronic controller circuitry EC1 can be executed by the at least two electronic controller circuits if needed or desired. The electronic controller circuitry EC1 can include at least two processors which are separately provided. The electronic controller circuitry EC1 can include at least two memories which are separately provided. The at least one control algorithm of the electronic controller circuitry EC1 can be executed by the at least two processors if needed or desired. The at least one control algorithm of the electronic controller circuitry EC1 can be stored in the at least two memories if needed or desired. The electronic controller circuitry EC1 can include at least two circuit boards which are separately provided if needed or desired. The electronic controller circuitry EC1 can include at least two system buses which are separately provided if needed or desired.

The wireless communicator circuitry WC1 is electrically mounted on the at least one circuit board EC13. The wireless communicator circuitry WC1 is configured to wirelessly communicate with another wireless communicator. For example, the wireless communicator circuitry WC1 includes signal transmitting circuitry WC11, signal receiving circuitry WC12, and antenna circuitry WC13. The signal transmitting circuitry WC11 is electrically connected to the antenna circuitry WC13. The signal receiving circuitry WC12 is electrically connected to the antenna circuitry WC13. The wireless communicator circuitry WC1 can also be referred to as a wireless communicator WC1 or wireless circuitry WC1.

The wireless communicator circuitry WC1 is configured to transmit wireless signals via the antenna circuitry WC13. The wireless communicator circuitry WC1 is configured to superimpose digital signals on carrier wave using a predetermined communication protocol to wirelessly transmit signals. In the present embodiment, the wireless communicator circuitry WC1 is configured to encrypt signals using a cryptographic key to generate encrypted wireless signals.

The wireless communicator circuitry WC1 is configured to receive wireless signals via the antenna circuitry WC13. In the present embodiment, the wireless communicator circuitry WC1 is configured to decode the wireless signals to recognize signals transmitted from other wireless communicators. The wireless communicator circuitry WC1 is configured to decrypt the wireless signals using the cryptographic key.

The wireless communicator circuitry WC1 includes signal amplifier circuitry WC14. The signal amplifier circuitry WC14 is coupled to the signal transmitting circuitry WC11, the signal receiving circuitry WC12, and the antenna circuitry WC13. The signal amplifier circuitry WC14 is configured to selectively amplify the signals of the antenna circuitry WC13. The signal amplifier circuitry WC14 can be controlled by the electronic controller circuitry EC1. The electronic controller circuitry EC1 can be configured to control the signal amplifier circuitry WC14 such that the signal amplifier circuitry WC14 operates in a low-power or high-power consumption state.

The electronic controller circuitry EC1 can include wired communicator circuitry. In such a modification, for example, the wired communicator circuitry is electrically connected to the electronic controller circuitry EC1. The wired communicator circuitry is configured to communicate with another wired communicator circuitry via an electrical cable. For example, the wired communicator circuitry is configured to communicate with a wired communicator of the gear changer 12 via an electrical cable.

The wired communicator circuitry is configured to communicate with another wired communicator using power line communication (PLC) technology. For example, the electrical cable includes a ground line and a voltage line that are detachably connected to a serial bus that is formed by communication interfaces. The wired communicator circuitry is configured to communicate with another wired communicator circuitry through the voltage line using the PLC technology. Since the PLC technology has been known, it will not be described in detail here for the sake of brevity.

The human-powered vehicle component BC1 includes a notification device BC12. The notification device BC12 is configured to be controlled by the electronic controller circuitry EC1. Here, the notification device BC12 includes a light emitter. For example, the notification device BC12 includes one or more light emitting diodes (LEDs). Here, the notification device BC12 includes a red LED, a blue LED and a green LED that can be selectively turned on by the electronic controller circuitry EC1 to produce different colors of light. In other words, the electronic controller circuitry EC1 is configured to control the notification device BC12 to selectively illuminate the LEDs of the notification device BC12. The electronic controller circuitry EC1 is configured to control the notification device BC12 to produce a notification (e.g., a solid continuous light or a flashing light of a predetermined color) indicating that a particular situation is occurring or has been completed.

The notification device BC12 includes a transparent window portion. The transparent window portion is configured to conduct light emitted from the light emitter to the outside of the human-powered vehicle component BC1. As seen in FIG. 2, in a case where the human-powered vehicle component BC1 includes the gear changer 12, for example, light emitted from the light emitter of the notification device BC12 passes through the transparent window portion provided to at least one of the base member 12A, the movable structure 12B, and other parts.

As seen in FIG. 9, the human-powered vehicle component BC1 includes a power source holder BC16. The power source holder BC16 is configured to detachably and reattachably hold an electric power source BC15. Examples of the electric power source BC15 includes a primary battery and a secondary battery. The power source holder BC16 is configured to be electrically connected to the electronic controller circuitry EC1, the wireless communicator circuitry WC1, and other electronic parts of the human-powered vehicle component BC1. For example, the power source holder BC16 is configured to be electrically connected to the electric actuator 12E, the actuator driver 12F, and other electronic parts of the gear changer 12 in a case where the human-powered vehicle component BC1 includes the gear changer 12. As seen in FIG. 2, the electric power source BC15 and the power source holder BC16 can be provided to at least one of the base member 12A, the linkage 12C, the chain guide 12D, and the movable member 12X in a case where the human-powered vehicle component BC1 includes the gear changer 12. As seen in FIG. 1, the electric power source BC15 and the power source holder BC16 can be provided to the vehicle body VB in a case where the human-powered vehicle component BC1 includes the assist drive unit 22. Electricity can be supplied from the electric power source BC15 of the assist drive unit 22 to another human-powered vehicle component such as the gear changer 12, the suspension 16, the suspension 18, and the adjustable seatpost 20. As seen in FIG. 3, the electric power source BC15 and the power source holder BC16 can be provided to at least one of the first longitudinal member 16A and the third longitudinal member 16C in a case where the human-powered vehicle component BC1 includes the suspension 16. As seen in FIG. 4, the electric power source BC15 and the power source holder BC16 can be provided to the first longitudinal member 18A in a case where the human-powered vehicle component BC1 includes the suspension 18. As seen in FIG. 5, the electric power source BC15 and the power source holder BC16 can be provided to the first longitudinal member 20A in a case where the human-powered vehicle component BC1 includes the adjustable seatpost 20.

The electric power source BC15 is configured to supply electrical power to the electronic controller circuitry EC1, the wireless communicator circuitry WC1, and other electronic parts of the human-powered vehicle component BC1 via the power source holder BC16. The electric power source BC15 is configured to supply electrical power to the electric actuator 12E, the actuator driver 12F, and other electronic parts of the gear changer 12 via the power source holder BC16 in a case where the human-powered vehicle component BC1 includes the gear changer 12. The power source holder BC16 can be electrically connected to a cable connector via an electric cable if needed or desired. The human-powered vehicle component BC1 can be configured to be powered by another electric power source electrically connected to the human-powered vehicle component BC1 via an electric cable if needed or desired.

As seen in FIG. 9, the additional electronic controller circuitry EC2 includes at least one processor EC21 and at least one memory EC22. The additional electronic controller circuitry EC2 includes at least one circuit board EC23 and at least one system bus EC24. The additional electronic controller circuitry EC2 is electrically mounted on the at least one circuit board EC23. The at least one processor EC21 and the at least one memory EC22 are electrically mounted on the at least one circuit board EC23. The at least one processor EC21 is coupled to the at least one memory EC22. The at least one memory EC22 is coupled to the at least one processor EC21. The at least one processor EC21 is electrically connected to the at least one memory EC22 via the at least one circuit board EC23 and the at least one system bus EC24. The at least one memory EC22 is electrically connected to the at least one processor EC21 via the at least one circuit board EC23 and the at least one system bus EC24. For example, the additional electronic controller circuitry EC2 includes at least one semiconductor. The at least one processor EC21 includes at least one semiconductor. The at least one memory EC22 includes at least one semiconductor.

For example, the at least one processor EC21 includes at least one of a central processing unit (CPU), a micro processing unit (MPU), a graphics processing unit (GPU), and a memory controller. The at least one memory EC22 is electrically connected to the at least one processor EC21. For example, the at least one memory EC22 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The at least one memory EC22 includes storage areas each having an address. The at least one processor EC21 is configured to control the at least one memory EC22 to store data in the storage areas of the at least one memory EC22 and reads data from the storage areas of the at least one memory EC22. The at least one processor EC21 can also be referred to as at least one hardware processor EC21, at least one processor circuit EC21, or processor circuitry EC21. The at least one memory EC22 can also be referred to as at least one hardware memory EC22, at least one memory circuit, or memory circuitry EC22. The at least one memory EC22 can also be referred to as a non-transitory computer-readable storage medium EC22. Namely, the additional electronic controller circuitry EC2 includes the non-transitory computer-readable storage medium EC22.

The additional electronic controller circuitry EC2 is configured to execute at least one control algorithm of the additional electronic controller circuitry EC2. For example, the additional electronic controller circuitry EC2 is programed to execute at least one control algorithm of the additional electronic controller circuitry EC2. The at least one memory EC22 stores at least one program including at least one computer program code. The at least one program is read into the at least one processor EC21, and thereby the at least one control algorithm of the additional electronic controller circuitry EC2 is executed based on the at least one program.

The structure of the additional electronic controller circuitry EC2 is not limited to the above structure. The structure of the additional electronic controller circuitry EC2 is not limited to the at least one processor EC21 and the at least one memory EC22. The additional electronic controller circuitry EC2 can be realized by hardware alone or a combination of hardware and software. In the present embodiment, the at least one processor EC21 and the at least one memory EC22 can be separate chips. Alternatively, the at least one processor EC21 and the at least one memory EC22 can be integrated as a single chip such as an application specific integrated circuit (ASIC) or a field programmable gate array (FPGA).

The additional electronic controller circuitry EC2 can include at least two electronic controller circuits which are separately provided. The at least one control algorithm of the additional electronic controller circuitry EC2 can be executed by the at least two electronic controller circuits if needed or desired. The additional electronic controller circuitry EC2 can include at least two processors which are separately provided. The additional electronic controller circuitry EC2 can include at least two memories which are separately provided. The at least one control algorithm of the additional electronic controller circuitry EC2 can be executed by the at least two processors if needed or desired. The at least one control algorithm of the additional electronic controller circuitry EC2 can be stored in the at least two memories if needed or desired. The additional electronic controller circuitry EC2 can include at least two circuit boards which are separately provided if needed or desired. The additional electronic controller circuitry EC2 can include at least two system buses which are separately provided if needed or desired.

The additional wireless communicator circuitry WC2 is electrically mounted on the at least one circuit board EC23. The additional wireless communicator circuitry WC2 is configured to wirelessly communicate with another wireless communicator. For example, the additional wireless communicator circuitry WC2 includes signal transmitting circuitry WC21, signal receiving circuitry WC22, and antenna circuitry WC23. The signal transmitting circuitry WC21 is electrically connected to the antenna circuitry WC23. The signal receiving circuitry WC22 is electrically connected to the antenna circuitry WC23. The additional wireless communicator circuitry WC2 can also be referred to as an additional wireless communicator WC2 or additional wireless circuitry WC2.

The additional wireless communicator circuitry WC2 is configured to transmit wireless signals via the antenna circuitry WC23. The additional wireless communicator circuitry WC2 is configured to superimpose digital signals on carrier wave using a predetermined communication protocol to wirelessly transmit signals. In the present embodiment, the additional wireless communicator circuitry WC2 is configured to encrypt signals using a cryptographic key to generate encrypted wireless signals.

The additional wireless communicator circuitry WC2 is configured to receive wireless signals via the antenna circuitry WC23. In the present embodiment, the additional wireless communicator circuitry WC2 is configured to decode the wireless signals to recognize signals transmitted from other wireless communicators. The additional wireless communicator circuitry WC2 is configured to decrypt the wireless signals using the cryptographic key.

The additional wireless communicator circuitry WC2 includes signal amplifier circuitry WC24. The signal amplifier circuitry WC24 is coupled to the signal transmitting circuitry WC21, the signal receiving circuitry WC22, and the antenna circuitry WC23. The signal amplifier circuitry WC24 is configured to selectively amplify the signals of the antenna circuitry WC23. The signal amplifier circuitry WC24 can be controlled by the additional electronic controller circuitry EC2. The additional electronic controller circuitry EC2 can be configured to control the signal amplifier circuitry WC24 such that the signal amplifier circuitry WC24 operates in a low-power or high-power consumption state.

The additional electronic controller circuitry EC2 can include additional wired communicator circuitry. In such modification, for example, the additional wired communicator circuitry is electrically connected to the additional electronic controller circuitry EC2. The additional wired communicator circuitry is configured to communicate with another additional wired communicator circuitry via an electrical cable. For example, the additional wired communicator circuitry is configured to communicate with the wired communicator circuitry of the human-powered vehicle component BC1 via an electrical cable.

The additional wired communicator circuitry is configured to communicate with another wired communicator using power line communication (PLC) technology. For example, the electrical cable includes a ground line and a voltage line that are detachably connected to a serial bus that is formed by communication interfaces. The additional wired communicator circuitry is configured to communicate with another additional wired communicator circuitry through the voltage line using the PLC technology. Since the PLC technology has been known, it will not be described in detail here for the sake of brevity.

As seen in FIG. 9, the additional human-powered vehicle component BC2 includes a notification device BC22. The notification device BC22 is configured to be controlled by the additional electronic controller circuitry EC2. Here, the notification device BC22 includes a light emitter. For example, the notification device BC22 includes one or more light emitting diodes (LEDs). Here, the notification device BC22 includes a red LED, a blue LED and a green LED that can be selectively turned on by the additional electronic controller circuitry EC2 to produce different colors of light. In other words, the additional electronic controller circuitry EC2 is configured to control the notification device BC22 to selectively illuminate the LEDs of the notification device BC22. The additional electronic controller circuitry EC2 is configured to control the notification device BC22 to produce a notification (e.g., a solid continuous light or a flashing light of a predetermined color) indicating that a particular situation is occurring or has been completed.

The notification device BC22 includes a transparent window portion. The transparent window portion is configured to conduct light emitted from the light emitter to the outside of the additional human-powered vehicle component BC2. As seen in FIG. 7, in a case where the additional human-powered vehicle component BC2 includes the operating device 24, for example, light emitted from the light emitter of the notification device BC22 passes through the transparent window portion provided to the housing 24A.

As seen in FIG. 9, the additional human-powered vehicle component BC2 includes a power source holder BC26. The power source holder BC26 is configured to detachably and reattachably hold an electric power source BC25. Examples of the electric power source BC25 includes a primary battery and a secondary battery. The power source holder BC26 is configured to be electrically connected to the additional electronic controller circuitry EC2, the additional wireless communicator circuitry WC2, and other electronic parts of the additional human-powered vehicle component BC2. For example, the power source holder BC26 is configured to be electrically connected to the user interface 24B and other electronic parts of the operating device 24 in a case where the additional human-powered vehicle component BC2 includes the operating device 24. As seen in FIG. 7, the electric power source BC15 and the power source holder BC16 can be provided to the housing 24A in a case where the human-powered vehicle component BC2 includes the operating device 24. As seen in FIG. 8, the electric power source BC15 and the power source holder BC16 can be provided to the housing 26A in a case where the human-powered vehicle component BC2 includes the operating device 26.

The electric power source BC25 is configured to supply electrical power to the additional electronic controller circuitry EC2, the additional wireless communicator circuitry WC2, and other electronic parts of the additional human-powered vehicle component BC2 via the power source holder BC26. The electric power source BC25 is configured to supply electrical power to the user interface 24B and other electronic parts of the operating device 24 via the power source holder BC26 in a case where the human-powered vehicle component BC2 includes the operating device 24. The power source holder BC26 can be electrically connected to a cable connector via an electric cable if needed or desired. The additional human-powered vehicle component BC2 can be configured to be powered by another electric power source electrically connected to the additional human-powered vehicle component BC2 via an electric cable if needed or desired.

As seen in FIG. 9, the human-powered vehicle component BC1 has firmware. The at least one memory EC12 is configured to store the firmware. The human-powered vehicle component BC1 is configured to update the firmware automatically or in response to a user operation. The update of the firmware may update a communication protocol used in the human-powered vehicle component BC1 from an old version to a new version.

The additional human-powered vehicle component BC2 has firmware. The at least one memory EC22 is configured to store the firmware. The additional human-powered vehicle component BC2 is configured to update the firmware automatically or in response to a user operation. The update of the firmware may update a communication protocol used in the additional human-powered vehicle component BC2 from an old version to a new version.

The wireless connection is established between the human-powered vehicle component BC1 and the additional human-powered vehicle component BC2 in a case where the version of the communication protocol used in the human-powered vehicle component BC1 is the same as the version of the communication protocol used in the additional human-powered vehicle component BC2.

However, the wireless connection is less likely to be established between the human-powered vehicle component BC1 and the additional human-powered vehicle component BC2 in a case where the version of the communication protocol used in the human-powered vehicle component BC1 is different from the version of the communication protocol used in the additional human-powered vehicle component BC2.

In such case, to establish the wireless connection between the human-powered vehicle component BC1 and the additional human-powered vehicle component BC2, the human-powered vehicle component BC1 and the additional human-powered vehicle component BC2 have the following configurations.

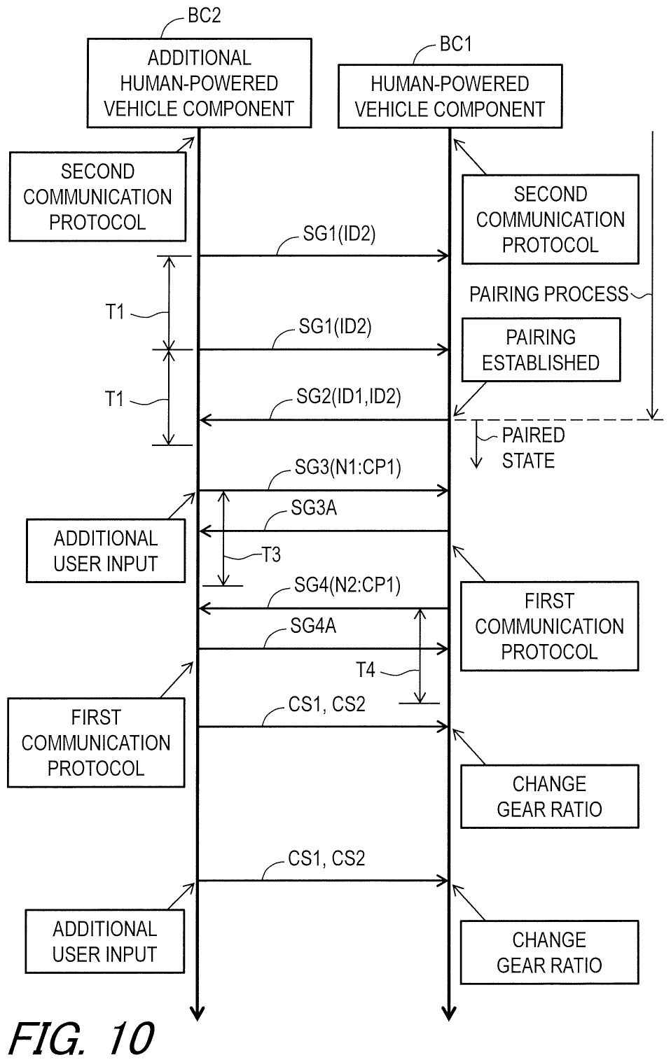

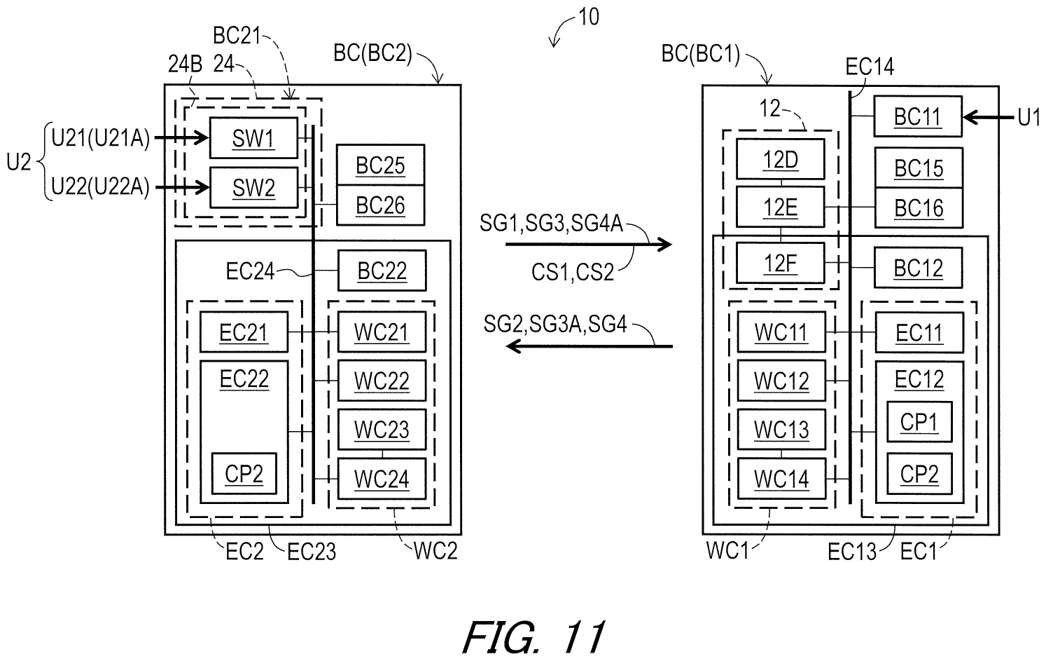

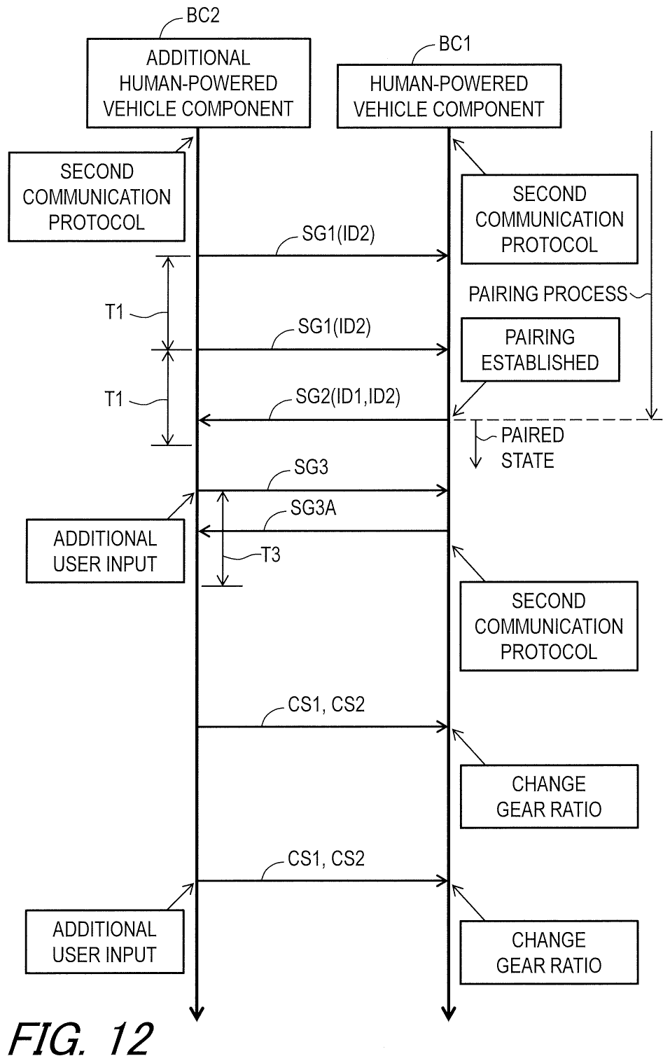

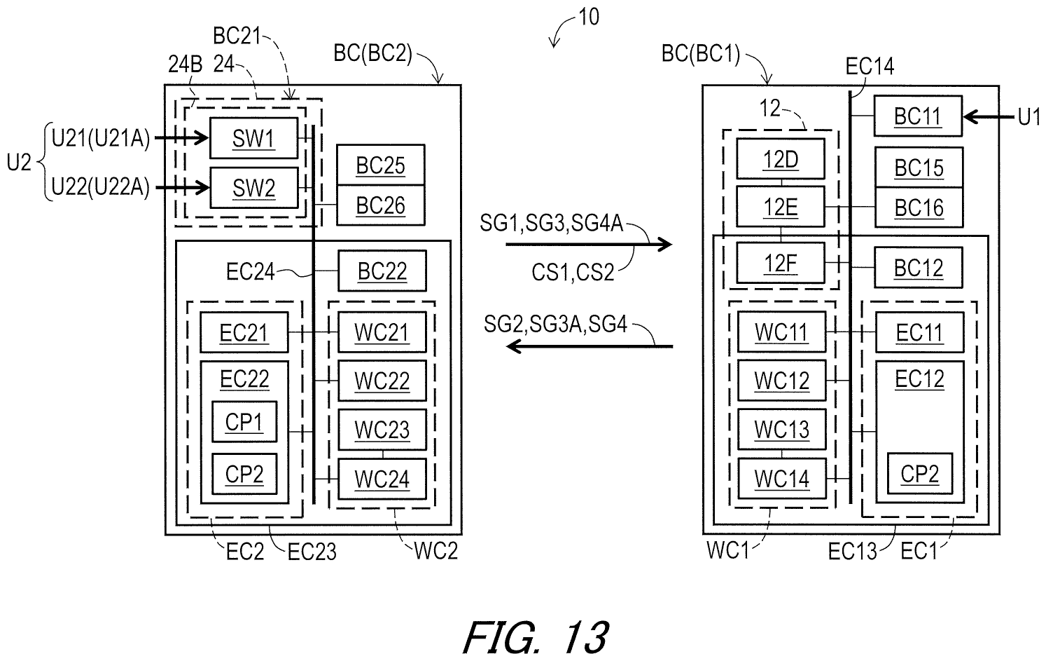

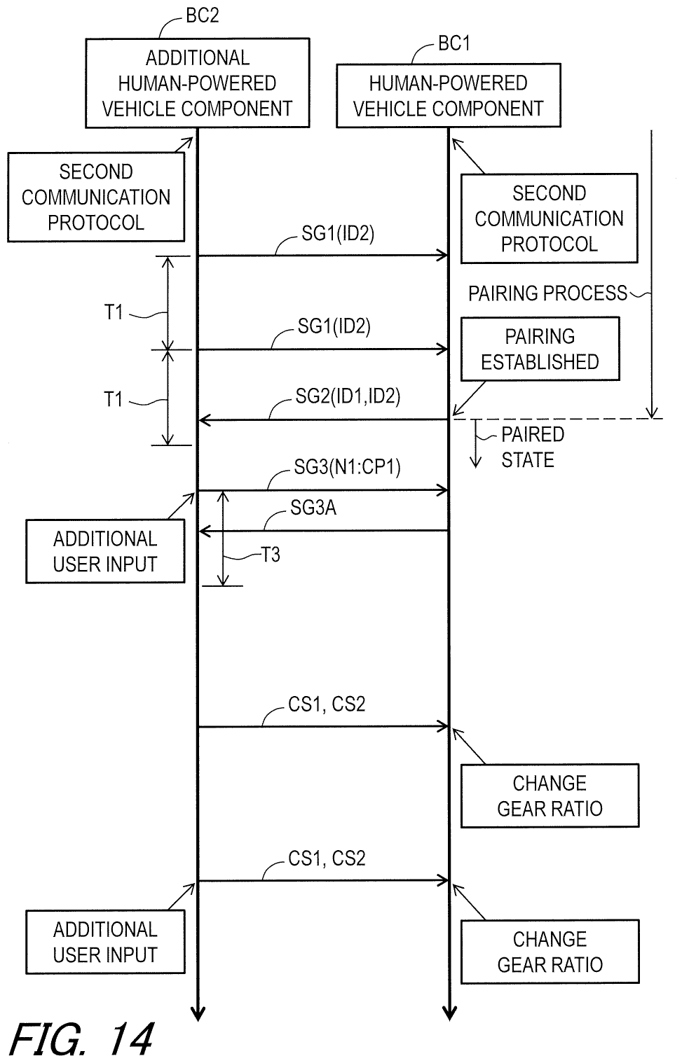

FIGS. 9 and 10 show a first scenario in which each of the human-powered vehicle component BC1 and the additional human-powered vehicle component BC2 is compatible with both a first communication protocol and a second communication protocol. FIGS. 11 and 12 show a second scenario in which the human-powered vehicle component BC1 is compatible with both the first communication protocol and the second communication protocol and in which the additional human-powered vehicle component BC2 is compatible with only the second communication protocol. FIGS. 13 and 14 show a third scenario in which the additional human-powered vehicle component BC2 is compatible with both the first communication protocol and the second communication protocol and in which the human-powered vehicle component BC1 is compatible with only the second communication protocol. For example, a version of the first communication protocol is newer than a version of the second communication protocol. Examples of the communication protocol of the wireless communicator circuitry WC1 or WC2 includes Bluetooth®, ANT™, ANT+™, or any other technique, protocol, and/or standards.

As seen in FIG. 9, in the first scenario, the electronic controller circuitry EC1 is configured to store the first communication protocol CP1 and the second communication protocol CP2 as the communication protocol of the wireless communicator circuitry WC1. The electronic controller circuitry EC1 is configured to store the first communication protocol CP1 and the second communication protocol CP2 as the communication protocol that can be used for the wireless communicator circuitry WC1. Each of the first communication protocol CP1 and the second communication protocol CP2 includes a protocol of the same communication technology such as Bluetooth®, ANT™, or ANT+™. For example, the first communication protocol CP1 and the second communication protocol CP2 include different versions of the same communication technology, respectively.

In the first scenario, the electronic controller circuitry EC1 is configured to store one of the first communication protocol CP1 and the second communication protocol CP2 in the at least one memory EC12 as an applied communication protocol which is currently used in the wireless communicator circuitry WC1.

In the first scenario, the electronic controller circuitry EC2 is configured to store the first communication protocol CP1 and the second communication protocol CP2 as the communication protocol of the wireless communicator circuitry WC2. The electronic controller circuitry EC2 is configured to store the first communication protocol CP1 and the second communication protocol CP2 as the communication protocol that can be used for the wireless communicator circuitry WC2.

In the first scenario, the electronic controller circuitry EC2 is configured to store one of the first communication protocol CP1 and the second communication protocol CP2 in the at least one memory EC22 as an applied communication protocol which is currently used in the wireless communicator circuitry WC2.

As seen in FIG. 11, in the second scenario, the electronic controller circuitry EC1 is configured to store the first communication protocol CP1 and the second communication protocol CP2 as the communication protocol of the wireless communicator circuitry WC1. The additional electronic controller circuitry EC2 is configured to store the second communication protocol CP2 as the communication protocol of the additional wireless communicator circuitry WC2. However, the additional electronic controller circuitry EC2 has not stored the first communication protocol CP1.

As seen in FIG. 13, in the third scenario, the electronic controller circuitry EC1 is configured to store the second communication protocol CP2 as the communication protocol of the wireless communicator circuitry WC1. However, the electronic controller circuitry EC1 has not stored the first communication protocol CP1. The electronic controller circuitry EC2 is configured to store the first communication protocol CP1 and the second communication protocol CP2 as the communication protocol of the wireless communicator circuitry WC2.

As seen in FIGS. 10 and 12, in the first and second scenarios, the human-powered vehicle component BC1 is configured to use, in a pairing process, the second communication protocol CP2 having the version which is older than the version of the first communication protocol CP1 while the human-powered vehicle component BC1 is compatible with both the first communication protocol CP1 and the second communication protocol CP2. In the first and second scenarios, the human-powered vehicle component BC1 is configured to use a pairing protocol in the pairing process regardless of whether the additional human-powered vehicle component BC2 is configured to use the first communication protocol CP1 or the second communication protocol CP2.

As seen in FIG. 14, in the third scenario, the human-powered vehicle component BC1 is configured to use the second communication protocol CP2 in the pairing process since the human-powered vehicle component BC1 is not compatible with the first communication protocol CP1. In the third scenario, the human-powered vehicle component BC1 is configured to use a pairing protocol in the pairing process regardless of whether the additional human-powered vehicle component BC2 is configured to use the first communication protocol CP1 or the second communication protocol CP2.

As seen in FIGS. 10 and 14, in the first and third scenarios, the additional human-powered vehicle component BC2 is configured to use the second communication protocol CP2 in the pairing process while the additional human-powered vehicle component BC2 is compatible with both the first communication protocol CP1 and the second communication protocol CP2. In the first and third scenarios, the additional human-powered vehicle component BC2 is configured to use the second communication protocol CP2 in the pairing process regardless of whether the human-powered vehicle component BC1 is configured to use the first communication protocol CP1.

As seen in FIG. 12, in the second scenario, the additional human-powered vehicle component BC2 is configured to use the second communication protocol CP2 in the pairing process since the additional human-powered vehicle component BC2 is not compatible with the first communication protocol CP1. In the second scenario, the additional human-powered vehicle component BC2 is configured to use the second communication protocol CP2 in the pairing process regardless of whether the human-powered vehicle component BC1 is configured to use the first communication protocol CP1.

As seen in FIGS. 9 to 12, in the first and second scenarios, the electronic controller circuitry EC1 is configured to control the wireless communicator circuitry WC1 to use the second communication protocol CP2 in the pairing process while the human-powered vehicle component BC1 is compatible with both the first communication protocol CP1 and the second communication protocol CP2. The electronic controller circuitry EC1 is configured to control the wireless communicator circuitry WC1 to use the pairing protocol in the pairing process regardless of whether the additional human-powered vehicle component BC2 is configured to use the first communication protocol CP1 or the second communication protocol CP2.

Each of the first communication protocol CP1, the second communication protocol CP2, and the pairing protocol of the wireless communication circuitry WC1 includes a protocol of the same communication technology such as Bluetooth®, ANT™, or ANT+™. The pairing protocol of the wireless communication circuitry WC1 is different from each of the first communication protocol CP1 and the second communication protocol CP2. The pairing protocol can be defined regardless of the version of the communication technology. Alternatively, the pairing protocol of the wireless communication circuitry WC1 can be the same as one of the first communication protocol CP1 and the second communication protocol CP2.

As seen in FIGS. 13 and 14, in the third scenario, the electronic controller circuitry EC1 is configured to control the wireless communicator circuitry WC1 to use the second communication protocol CP2 in the pairing process since the human-powered vehicle component BC1 is not compatible with the first communication protocol CP1. In the third scenario, the electronic controller circuitry EC1 is configured to control the wireless communicator circuitry WC1 to use the second communication protocol CP2 in the pairing process regardless of whether the additional human-powered vehicle component BC2 is configured to use the first communication protocol CP1.

As seen in FIGS. 9, 10, 13, and 14, in the first and third scenarios, the additional electronic controller circuitry EC2 is configured to control the additional wireless communicator circuitry WC2 to use the second communication protocol CP2 in the pairing process while the additional human-powered vehicle component BC2 is compatible with both the first communication protocol CP1 and the second communication protocol CP2. The electronic controller circuitry EC2 is configured to control the wireless communicator circuitry WC2 to use the pairing protocol in the pairing process regardless of whether the additional human-powered vehicle component BC1 is configured to use the first communication protocol CP1 or the second communication protocol CP2.

Each of the first communication protocol CP1, the second communication protocol CP2, and the pairing protocol of the wireless communication circuitry WC2 includes a protocol of the same communication technology such as Bluetooth®, ANT™, or ANT+™. The pairing protocol of the wireless communication circuitry WC2 is different from each of the first communication protocol CP1 and the second communication protocol CP2. Alternatively, the pairing protocol of the wireless communication circuitry WC2 can be the same as one of the first communication protocol CP1 and the second communication protocol CP2.

As seen in FIGS. 11 and 12, in the second scenario, the additional electronic controller circuitry EC2 is configured to control the additional wireless communicator circuitry WC2 to use the second communication protocol CP2 in the pairing process since the additional human-powered vehicle component BC2 is not compatible with the first communication protocol CP1. In the second scenario, the additional electronic controller circuitry EC2 is configured to control the additional wireless communicator circuitry WC2 to use the second communication protocol CP2 in the pairing process regardless of whether the human-powered vehicle component BC1 is configured to use the first communication protocol CP1.

As seen in FIGS. 10, 12, and 14, in the pairing process of the first to third scenarios, the human-powered vehicle component BC1 is configured to transmit identification information ID1 of the human-powered vehicle component BC1 and to receive identification information of another human-powered vehicle component such as identification information ID2 of the additional human-powered vehicle component BC2. In the pairing process of the first to third scenarios, the additional human-powered vehicle component BC2 is configured to transmit the identification information ID2 of the additional human-powered vehicle component BC2 and to receive identification information of another human-powered vehicle component such as the identification information ID1 of the human-powered vehicle component BC1.

In the pairing process of the first to third scenarios, for example, the additional human-powered vehicle component BC2 is configured to wirelessly transmit an advertising signal SG1 in the pairing process using the second communication protocol CP2. The advertising signal SG1 is used for establishing the wireless connection between the human-powered vehicle component BC1 and the additional human-powered vehicle component BC2. The additional human-powered vehicle component BC2 is configured to wirelessly transmit the advertising signal SG1 at an advertising interval T1 in the pairing process using the second communication protocol CP2.

The additional electronic controller circuitry EC2 is configured to control the additional wireless communicator circuitry WC2 to wirelessly transmit the advertising signal SG1 using the second communication protocol CP2. For example, the advertising signal SG1 has no specified recipient. The advertising signal SG1 includes the identification information ID2 of the additional human-powered vehicle component BC2.

The identification information ID2 includes a unique number indicating the additional human-powered vehicle component BC2. Examples of the unique number include an address of the additional human-powered vehicle component BC2. The additional electronic controller circuitry EC2 is configured to store the identification information ID2 in the at least one memory EC22.

The additional human-powered vehicle component BC2 is configured to wirelessly transmit the advertising signal SG1 in response to a second trigger. The additional human-powered vehicle component BC2 is configured to wirelessly transmit the advertising signal SG1 in response to the second trigger in the state where the wireless connection is not established. The additional electronic controller circuitry EC2 is configured to control the additional wireless communicator circuitry WC2 to wirelessly transmit the advertising signal SG1 in response to the second trigger in the state where the wireless connection is not established.

For example, the second trigger includes at least one of: a user pairing input received by the user interface BC21; providing electrical power to the additional human-powered vehicle component BC2; connecting an electrical power source to the additional human-powered vehicle component BC2; connecting, to the additional human-powered vehicle component BC2, an electrical cable connected to another human-powered vehicle component; operating an operating device configured to control another human-powered vehicle component; and providing an output from a sensor to the additional human-powered vehicle component BC2.

In one case, for example, the second trigger can occur when an electric power source such as a battery is attached to the additional human-powered vehicle component BC2 either directly or indirectly such that the electrical power is supplied to the additional human-powered vehicle component BC2. In another case, for example, the second trigger can occur when an electrical cable is connected to one of another human-powered vehicle component, and then connected to the additional human-powered vehicle component BC2. In another case, for example, the second trigger can occur when the user interface of the additional human-powered vehicle component BC2 is operated to turn on the additional human-powered vehicle component BC2. In another case, for example, the additional human-powered vehicle component BC2 receives the output, which indicates that the human-powered vehicle B is used or moves, from the sensor such as an acceleration sensor, a motion sensor, and a force sensor.

As seen in FIGS. 9 to 14, in the pairing process of the first to third scenarios, the human-powered vehicle component BC1 is configured to wirelessly receive the advertising signal SG1 in the pairing process using the second communication protocol CP2. The human-powered vehicle component BC1 is configured to scan the advertising signal SG1 in the pairing process using the second communication protocol CP2.

The electronic controller circuitry EC1 is configured to control the wireless communicator circuitry WC1 to scan the advertising signal SG1 in the pairing process using the second communication protocol CP2. The electronic controller circuitry EC1 is configured to recognize the identification information ID2 included in the advertising signal SG1 wirelessly received by the wireless communicator circuitry WC1. The electronic controller circuitry EC1 is configured to at least partially store the identification information ID2 included in the advertising signal SG1. For example, the electronic controller circuitry EC1 is configured to store, in the at least one memory EC12, the identification information ID2 included in the advertising signal SG1.

The human-powered vehicle component BC1 is configured to start to scan the advertising signal SG1 in response to a first trigger. The human-powered vehicle component BC1 is configured to start to scan the advertising signal SG1 in response to the first trigger in the state where the wireless connection is not established. The electronic controller circuitry EC1 is configured to control the wireless communicator circuitry WC1 to start to scan an advertising signal such as the advertising signal SG1 for an advertisement scanning time in response to the first trigger in the state where the wireless connection is not established.

For example, the first trigger includes at least one of: a user pairing input received by the user interface BC11; providing electrical power to the human-powered vehicle component BC1; connecting an electrical power source to the human-powered vehicle component BC1; connecting, to the human-powered vehicle component BC1, an electrical cable connected to another human-powered vehicle component; operating an operating device configured to control another human-powered vehicle component; and providing an output from a sensor to the human-powered vehicle component BC1.

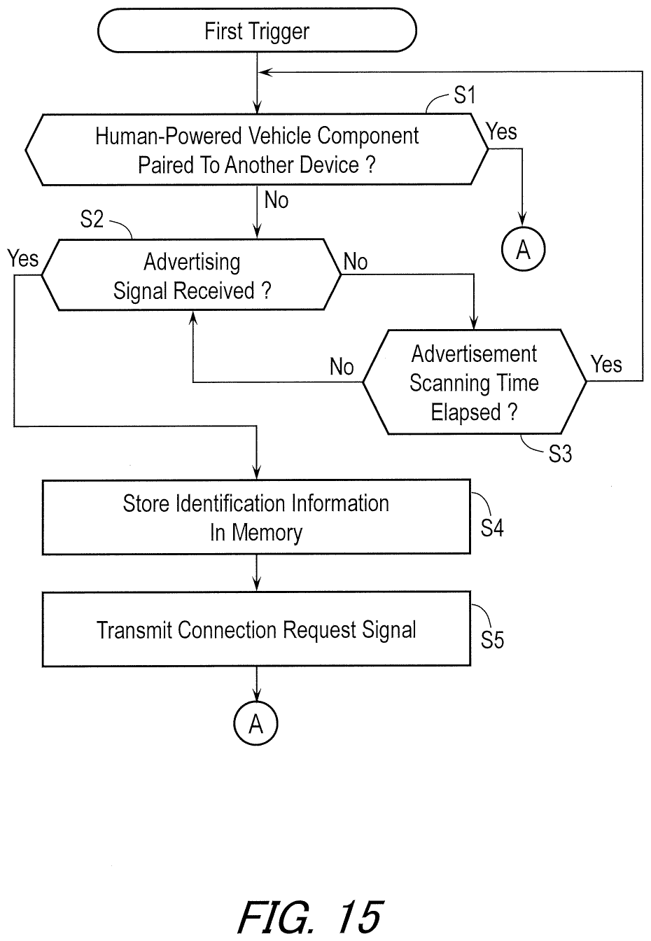

In one case, for example, the first trigger can occur when an electric power source such as a battery is attached to the human-powered vehicle component BC1 either directly or indirectly such that the electrical power is supplied to the human-powered vehicle component BC1. In another case, for example, the first trigger can occur when an electrical cable is connected to one of another human-powered vehicle component, and then connected to the human-powered vehicle component BC1. In another case, for example, the first trigger can occur when the user interface of the human-powered vehicle component BC1 is operated to turn on the human-powered vehicle component BC1. In another case, for example, the human-powered vehicle component BC1 receives the output, which indicates that the human-powered vehicle B is used or moves, from the sensor such as an acceleration sensor, a motion sensor, and a force sensor. In another case, the first trigger can be receipt of a signal transmitted from the additional human-powered vehicle component BC2. For example, the first trigger can be receipt of an advertising signal transmitted from the additional human-powered vehicle component BC2 in response to an operation of the user interface of the additional human-powered vehicle component BC2. In such modifications, the human-powered vehicle component BC1 can be configured to determine whether the human-powered vehicle component BC1 receives an additional advertising signal transmitted from the additional human-powered vehicle component BC2 in response to an additional operation of the user interface of the additional human-powered vehicle component BC2 in step S2 depicted in FIG. 15.

As seen in FIGS. 9 to 14, the human-powered vehicle component BC1 is configured to wirelessly transmit a connection request signal SG2 in the pairing process using the second communication protocol CP2 in response to the advertising signal SG1.

The electronic controller circuitry EC1 is configured to control the wireless communicator circuitry WC1 to wirelessly transmit the connection request signal SG2 in the pairing process using the second communication protocol CP2 in response to the advertising signal SG1.

For example, the connection request signal SG2 has a specified recipient such as the additional human-powered vehicle component BC2. The connection request signal SG2 includes identification information ID1 of the human-powered vehicle component BC1. The electronic controller circuitry EC1 is configured to store the identification information ID1 in the at least one memory EC12.

The identification information ID1 includes a unique number indicating the human-powered vehicle component BC1. Examples of the unique number include an address of the human-powered vehicle component BC1. The electronic controller circuitry EC1 is configured to store the identification information ID1 in the at least one memory EC12.

The connection request signal SG2 includes, as information indicating a specified recipient, the identification information ID2 obtained from the advertising signal SG1. At least one of the electronic controller circuitry EC1 and the wireless communicator circuitry WC1 is configured to generate the connection request signal SG2 including both the identification information ID1 and the identification information ID2. The electronic controller circuitry EC1 is configured to control the wireless communicator circuitry WC1 to wirelessly transmit the connection request signal SG2 including both the identification information ID1 and the identification information ID2. Thus, the connection request signal SG2 has a specified recipient which is the additional human-powered vehicle component BC2.

As seen in FIGS. 9 to 14, the additional human-powered vehicle component BC2 is configured to wirelessly receive the connection request signal SG2 in the state where the wireless connection is not established. The additional human-powered vehicle component BC2 is configured to detect the connection request signal SG2 in the state where the wireless connection is not established.

The additional electronic controller circuitry EC2 is configured to control the additional wireless communicator circuitry WC2 to start to scan the connection request signal SG2, which includes the identification information ID1 of the human-powered vehicle component BC1, after the transmission of the advertising signal SG1. The additional electronic controller circuitry EC2 is configured to control the additional wireless communicator circuitry WC2 to wirelessly transmit the advertising signal SG1 again in a case where the additional wireless communicator circuitry WC2 does not detect the connection request signal SG2 including the identification information ID1 for the advertising interval T1.

The additional electronic controller circuitry EC2 is configured to recognize the identification information ID1 and the identification information ID2 which are included in the connection request signal SG2 in a case where the additional wireless communicator circuitry WC2 detects the connection request signal SG2. The additional electronic controller circuitry EC2 is configured to store, in the at least one memory EC22, the identification information ID1 included in the connection request signal SG2.

In the present embodiment, the human-powered vehicle component BC1 and the additional human-powered vehicle component BC2 are paired based on receipt of the connection request signal SG2 in the pairing process. For example, the human-powered vehicle component BC1 and the additional human-powered vehicle component BC2 are paired in a case where the human-powered vehicle component BC1 and the additional human-powered vehicle component BC2 exchange the identification information ID1 and the identification information ID2 using the advertising signal SG1 and the connection request signal SG2, respectively. However, the human-powered vehicle component BC1 and the additional human-powered vehicle component BC2 are paired based on receipt of the advertising signal SG1 by the human-powered vehicle component BC1 if needed or desired.

After the pairing process in which the exchange of the identification information ID1 and the identification information ID2 between the human-powered vehicle component BC1 and the additional human-powered vehicle component, the human-powered vehicle component BC1 determines the communication protocol of the additional human-powered vehicle component BC2.

As seen in FIGS. 9 to 14, the additional human-powered vehicle component BC2 is configured to wirelessly transmit a first signal SG3 in response to the additional user input U21 or U22 received by the additional user interface BC21 of the additional human-powered vehicle component BC2. The additional electronic controller circuitry EC2 is configured to control the additional wireless communicator circuitry WC2 to wirelessly transmit the first signal SG3 in response to the additional user input U2 (e.g., the additional user input U21 or U22).

The additional user input U21 includes an additional user gear-change input U21A in a case where the additional human-powered vehicle component BC2 includes the operating device 24. The additional user gear-change input U21A is indicative of one of upshifting and downshifting executed by the gear changer 12. The additional user interface BC21 is configured to receive the additional user gear-change input U21A. Namely, the user interface BC21 is configured to receive the user gear-change input U21A. The additional electronic controller circuitry EC2 is configured to control the additional wireless communicator circuitry WC2 to wirelessly transmit the first signal SG3 in response to the additional user gear-change input U21A.

The additional user input U22 includes an additional user gear-change input U22A in a case where the additional human-powered vehicle component BC2 includes the operating device 24. The additional user gear-change input U22A is indicative of the other of upshifting and downshifting executed by the gear changer 12. The additional user interface BC21 is configured to receive the additional user gear-change input U22A. Namely, the user interface BC21 is configured to receive the user gear-change input U22A. The additional electronic controller circuitry EC2 is configured to control the additional wireless communicator circuitry WC2 to wirelessly transmit the first signal SG3 in response to the additional user gear-change input U22A.

The additional human-powered vehicle component BC2 is configured to wirelessly transmit the first signal SG3 in response to the additional user gear-change input U21A or U22A received by the additional user interface BC21 of the additional human-powered vehicle component BC2. The additional electronic controller circuitry EC2 is configured to control the additional wireless communicator circuitry WC2 to wirelessly transmit the first signal SG3 in response to the additional user gear-change input U21A or U22A. The additional user input U21 can include another user input other than the additional user gear-change input U21A. The additional user input U22 can include another user input other than the additional user gear-change input U22A.

In the first to third scenarios, the additional human-powered vehicle component BC2 is configured to use the second communication protocol CP2 as the communication protocol of the additional wireless communication circuitry WC2 in a paired state where the additional human-powered vehicle component BC2 is paired with the human-powered vehicle component BC1. Thus, the additional human-powered vehicle component BC2 is configured to wirelessly transmit the first signal SG3 using the second communication protocol CP2.

The first signal SG3 can also be referred to as a second signal SG3. Thus, the additional human-powered vehicle component BC2 is configured to wirelessly transmit the second signal SG3 using the second communication protocol CP2. The electronic controller circuitry EC2 is configured to wirelessly transmit the second signal SG3 using the second communication protocol CP2 via the wireless communicator circuitry WC2. The electronic controller circuitry EC2 is configured to transmit the second signal SG3 wirelessly via the wireless communicator circuitry WC2 in response to the user input U2 received by the user interface BC21. The electronic controller circuitry EC2 is configured to transmit the second signal SG3 wirelessly via the wireless communicator circuitry WC2 in response to the user input U21 or U22 received by the user interface BC21. The electronic controller circuitry EC2 is configured to transmit the second signal SG3 wirelessly via the wireless communicator circuitry WC2 in response to the user gear-change input U21A or U22A received by the user interface BC21.

As seen in FIGS. 10 and 14, in the first and third scenarios, the first signal SG3 includes first information N1 indicative of the first communication protocol CP1. The first information N1 can also be referred to as second information N1. Thus, in the first and third scenarios, the second signal SG3 includes the second information N1 indicative of the first communication protocol CP1. The electronic controller circuitry EC2 is configured to transmit wirelessly, via the wireless communicator circuitry WC2, the second signal SG3 including the second information N1 indicative of the first communication protocol CP1.

As seen in FIG. 12, in the second scenario, the first signal SG3 is free of the first information N1 indicative of the first communication protocol CP1 since the additional human-powered vehicle component BC2 is not compatible with the first communication protocol CP1 in the second scenario. Alternatively, the first signal SG3 can include the first information N1 indicative of a communication protocol (e.g., the second communication protocol CP2) other than the first communication protocol CP1.

In the first to third scenarios, the human-powered vehicle component BC1 is configured to use the second communication protocol CP2 as the communication protocol of the wireless communication circuitry WC1 in a paired state where the human-powered vehicle component BC1 is paired with the additional human-powered vehicle component BC2. The electronic controller circuitry EC1 is configured to control the wireless communicator circuitry WC1 to use the second communication protocol CP2 before receipt of the first signal SG3 in the paired state where the human-powered vehicle component BC1 is paired with the additional human-powered vehicle component BC2.

As seen in FIGS. 9 to 14, in the first to third scenarios, the electronic controller circuitry EC1 is configured to receive the first signal SG3 from the additional wireless communicator circuitry WC2 via the wireless communicator circuitry WC1. The electronic controller circuitry EC1 is configured to wirelessly receive, via the wireless communicator circuitry WC1, the first signal SG3 transmitted using the second communication protocol CP2. In the first and third scenarios, as seen in FIGS. 10 and 14, the first signal SG3 includes first information N1 indicative of the first communication protocol CP1. The first information N1 includes information indicating that the additional human-powered vehicle component BC2 is compatible with the first communication protocol CP1 which is the newer version than the version of the second communication protocol CP2. In the second scenario, as seen in FIG. 12, the first signal SG3 is free of information indicating that the additional human-powered vehicle component BC2 is compatible with the first communication protocol CP1.

As seen in FIGS. 9 to 14, in the first to third scenarios, the electronic controller circuitry EC1 is configured to transmit an acknowledgement signal SG3A via the wireless communicator circuitry WC1 in response to the first signal SG3 regardless of whether the first signal SG3 includes the first information N1 indicative of the first communication protocol CP1 or the second communication protocol CP2. The electronic controller circuitry EC1 is configured to transmit the acknowledgement signal SG3A via the wireless communicator circuitry WC1 using the second communication protocol CP2.

In the first to third scenarios, the additional electronic controller circuitry EC2 is configured to receive the acknowledgement signal SG3A via the additional wireless communicator circuitry WC2 after transmitting the first signal SG3. The additional electronic controller circuitry EC2 can be configured to transmit the first signal SG3 again via the additional wireless communicator circuitry WC2 in a case where the additional electronic controller circuitry EC2 does not receive the acknowledgement signal SG3A via the additional wireless communicator circuitry WC2 after transmitting the first signal SG3. Furthermore, the additional electronic controller circuitry EC2 can be configured to transmit the first signal SG3 repeatedly during a predetermined period via the additional wireless communicator circuitry WC2 in a case where the additional electronic controller circuitry EC2 receives the acknowledgement signal SG3A via the additional wireless communicator circuitry WC2 after transmitting the first signal SG3. In such modifications, it is possible to transmit the control signal CS1 or CS2 after the transmission of the first signal SG3 based on the single operation of the user interface BC21 of the additional human-powered vehicle component BC2, improving the usability of the additional human-powered vehicle component BC2.

As seen in FIGS. 9 and 10, in the first scenario, the electronic controller circuitry EC1 is configured to change the communication protocol of the wireless communicator circuitry WC1 from the second communication protocol CP2 to the first communication protocol CP1 based on the first signal SG3 in a case where the first signal SG3 includes the first information N1 indicative of the first communication protocol CP1. The electronic controller circuitry EC1 is configured to change the communication protocol of the wireless communicator circuitry WC1 from the second communication protocol CP2 to the first communication protocol CP1 based on the first signal SG3 in a case where the first signal SG3 includes the first information N1 indicative of the first communication protocol CP1 in the paired state where the human-powered vehicle component BC1 is paired with the additional human-powered vehicle component BC2.

As seen in FIGS. 11 to 14, in the second and third scenarios, the electronic controller circuitry EC1 is configured to control the wireless communicator circuitry WC1 to maintain use of the second communication protocol CP2 in a case where the electronic controller circuitry EC1 does not receive, via the wireless communicator circuitry WC1, the first signal SG3 including the first information N1 indicative of the first communication protocol CP1.

As seen in FIGS. 11 and 12, in the second scenario, the electronic controller circuitry EC1 is configured to maintain use of the second communication protocol CP2 based on the first signal SG3 in a case where the first signal SG3 includes the first information N1 indicative of the second communication protocol CP2.

As seen in FIGS. 9 and 10, in the first scenario, the electronic controller circuitry EC1 is configured to wirelessly transmit the second signal SG4 using the first communication protocol CP1 via the wireless communicator circuitry WC1. The electronic controller circuitry EC1 is configured to transmit wirelessly, via the wireless communicator circuitry WC1, a second signal SG4 including second information N2 indicative of the first communication protocol CP1. The electronic controller circuitry EC1 is configured to wirelessly transmit the second signal SG4 using the first communication protocol CP1 via the wireless communicator circuitry WC1. The electronic controller circuitry EC1 is configured to wirelessly transmit the second signal SG4 using the first communication protocol CP1 via the wireless communicator circuitry WC1 in response to the first signal SG3. The second signal SG4 can also be referred to as a first signal SG4. The second information N2 can be referred to as first information N2. Thus, in the first scenario, the first signal SG4 includes the first information N2 indicative of the first communication protocol CP1.

The electronic controller circuitry EC1 is configured to control the wireless communicator circuitry WC1 to transmit a signal wirelessly via the wireless communicator circuitry WC1 using the second communication protocol CP2 in the paired state in a case where the electronic controller circuitry EC1 stores the second communication protocol CP2 as the applied communication protocol in the at least one memory EC12. On the other hand, the electronic controller circuitry EC1 is configured to control the wireless communicator circuitry WC1 to receive a signal wirelessly via the wireless communicator circuitry WC1 using both the first communication protocol CP1 and the second communication protocol CP2 in the paired state in a case where the electronic controller circuitry EC1 stores the second communication protocol CP2 as the applied communication protocol in the at least one memory EC12.

The electronic controller circuitry EC2 is configured to control the wireless communicator circuitry WC2 to use the second communication protocol CP2 before receipt of the first signal SG4 in the paired state where the human-powered vehicle component BC2 is paired with the additional human-powered vehicle component BC1. The electronic controller circuitry EC2 is configured to control the wireless communicator circuitry WC2 to transmit a signal wirelessly via the wireless communicator circuitry WC2 using the second communication protocol CP2 in the paired state in a case where the electronic controller circuitry EC2 stores the second communication protocol CP2 as the applied communication protocol in the at least one memory EC22. On the other hand, the electronic controller circuitry EC2 is configured to control the wireless communicator circuitry WC2 to receive a signal wirelessly via the wireless communicator circuitry WC2 using both the first communication protocol CP1 and the second communication protocol CP2 in the paired state in a case where the electronic controller circuitry EC2 stores the second communication protocol CP2 as the applied communication protocol in the at least one memory EC22.

As seen in FIGS. 9 and 10, in the first scenario, the electronic controller circuitry EC2 is configured to receive the first signal SG4 from the additional wireless communicator circuitry WC1 via the wireless communicator circuitry WC2. The electronic controller circuitry EC2 is configured to wirelessly receive, via the wireless communicator circuitry WC2, the first signal SG4 transmitted using the second communication protocol CP2.

The electronic controller circuitry EC2 is configured to change the communication protocol of the wireless communicator circuitry WC2 from the second communication protocol CP2 to the first communication protocol CP1 based on the first signal SG4 in a case where the first signal SG4 includes the first information N2 indicative of the first communication protocol CP1. The electronic controller circuitry EC2 is configured to change the communication protocol of the wireless communicator circuitry WC2 from the second communication protocol CP2 to the first communication protocol CP1 based on the first signal SG4 in a case where the first signal SG4 includes the first information N2 indicative of the first communication protocol CP1 in the paired state where the human-powered vehicle component BC2 is paired with the additional human-powered vehicle component BC1. The first information N2 includes information indicating that the additional human-powered vehicle component BC2 is compatible with the first communication protocol CP1 which is the newer version than the version of the second communication protocol CP2.

As seen in FIGS. 9 and 10, in the first scenario, the electronic controller circuitry EC2 is configured to transmit an acknowledgement signal SG4A via the wireless communicator circuitry WC2 in response to the first signal SG4 regardless of whether the first signal SG4 includes the first information N2 indicative of the first communication protocol CP1 or the second communication protocol CP2. The electronic controller circuitry EC2 is configured to transmit the acknowledgement signal SG4A via the wireless communicator circuitry WC1 using the second communication protocol CP2.

In the first scenario, the additional electronic controller circuitry EC1 is configured to receive the acknowledgement signal SG4A via the additional wireless communicator circuitry WC1 after transmitting the first signal SG4. The additional electronic controller circuitry EC1 can be configured to transmit the first signal SG4 again via the additional wireless communicator circuitry WC1 in a case where the additional electronic controller circuitry EC1 does not receive the acknowledgement signal SG4A via the additional wireless communicator circuitry WC1 after transmitting the first signal SG4.

As seen in FIGS. 11 to 14, in the second and third scenarios, the electronic controller circuitry EC2 is configured to control the wireless communicator circuitry WC2 to maintain use of the second communication protocol CP2 in a case where the electronic controller circuitry EC2 does not receive, via the wireless communicator circuitry WC2, the first signal SG4 including the first information N1 indicative of the first communication protocol CP1.

As described above, in the first to third scenarios, the human-powered vehicle component BC1 automatically completes the setting of the communication protocol of the wireless communicator circuitry WC1 by operating the user interface BC21 of the additional human-powered vehicle component BC2 once. The additional human-powered vehicle component BC2 automatically completes the setting of the communication protocol of the additional wireless communicator circuitry WC2 by operating the user interface BC21 of the additional human-powered vehicle component BC2 once.

As seen in FIGS. 9 and 10, in the first scenario, the electronic controller circuitry EC2 is configured to transmit or receive a control signal CS1 or CS2 via the wireless communicator circuitry WC2 using the first communication protocol CP1 after the electronic controller circuitry EC2 changes the communication protocol from the second communication protocol CP2 to the first communication protocol CP1. The electronic controller circuitry EC2 is configured to transmit the control signal CS1 or CS2 via the wireless communicator circuitry WC2 using the first communication protocol CP1 after the electronic controller circuitry EC2 changes the communication protocol from the second communication protocol CP2 to the first communication protocol CP1.

For example, the electronic controller circuitry EC2 is configured to transmit, via the wireless communication circuitry WC2 using the first communication protocol CP1, the control signal CS1 or CS2 for upshifting or downshifting of the gear changer 12 of the human-powered vehicle component BC1 based on the user input U21 or U22 which triggers the transmission of the first signal SG3. The electronic controller circuitry EC2 is configured to transmit the control signal CS1 or CS2 via the wireless communication circuitry WC2 using the first communication protocol CP1 in response to the completion of the setting of the communication protocol from the second communication protocol CP2 to the first communication protocol CP1. The electronic controller circuitry EC1 is configured to transmit, via the wireless communication circuitry WC2 using the first communication protocol CP1, the control signal CS1 indicative of upshifting of the gear changer 12 in a case where the user interface BC21 receives the additional user gear-change input U21A. The electronic controller circuitry EC1 is configured to transmit, via the wireless communication circuitry WC2 using the first communication protocol CP1, the control signal CS2 indicative of downshifting of the gear changer 12 in a case where the user interface BC21 receives the additional user gear-change input U22A. Alternatively, the electronic controller circuitry EC2 can be configured to transmit, via the wireless communication circuitry WC2 using the first communication protocol CP1, the control signal CS1 or CS2 in response to the additional user gear-change input U21A or U22A which is received by the user interface BC21 after the transmission of the first signal SG3.

As seen in FIGS. 11 to 14, in the second and third scenarios, the electronic controller circuitry EC2 is configured to transmit or receive the control signal CS1 or CS2 via the wireless communicator circuitry WC2 using the second communication protocol CP2 in a case where the electronic controller circuitry EC2 maintains use of the second communication protocol CP2. The electronic controller circuitry EC2 is configured to transmit the control signal CS1 or CS2 via the wireless communicator circuitry WC2 using the second communication protocol CP2 in a case where the electronic controller circuitry EC2 maintains use of the second communication protocol CP2.

For example, the electronic controller circuitry EC2 is configured to transmit, via the wireless communication circuitry WC2 using the second communication protocol CP2, the control signal CS1 or CS2 for upshifting or downshifting of the gear changer 12 of the human-powered vehicle component BC1 based on the user input U21 or U22 which triggers the transmission of the first signal SG3. The electronic controller circuitry EC2 is configured to transmit the control signal CS1 or CS2 via the wireless communication circuitry WC2 using the second communication protocol CP2 in a case where a determination time T2 elapses without the receipt of the second signal SG4 after transmitting the first signal SG3. The electronic controller circuitry EC1 is configured to transmit, via the wireless communication circuitry WC2 using the second communication protocol CP2, the control signal CS1 indicative of upshifting of the gear changer 12 in a case where the user interface BC21 receives the additional user gear-change input U21A. The electronic controller circuitry EC1 is configured to transmit, via the wireless communication circuitry WC2 using the second communication protocol CP2, the control signal CS2 indicative of downshifting of the gear changer 12 in a case where the user interface BC21 receives the additional user gear-change input U22A. Alternatively, the electronic controller circuitry EC2 can be configured to transmit the control signal CS1 or CS2 via the wireless communicator circuitry WC2 using the second communication protocol CP2 in response to the additional user gear-change input U21A or U22A which is received by the user interface BC21 after the determination time T2 elapses.

As seen in FIGS. 9 and 10, in the first scenario, the electronic controller circuitry EC1 is configured to transmit or receive the control signal CS1 or CS2 via the wireless communicator circuitry WC1 using the first communication protocol CP1 after the electronic controller circuitry EC1 changes the communication protocol from the second communication protocol CP2 to the first communication protocol CP1. The electronic controller circuitry EC1 is configured to receive the control signal CS1 or CS2 via the wireless communicator circuitry WC1 using the first communication protocol CP1 after the electronic controller circuitry EC1 changes the communication protocol from the second communication protocol CP2 to the first communication protocol CP1.

As seen in FIGS. 11 to 14, in the second and third scenarios, the electronic controller circuitry EC1 is configured to transmit or receive the control signal CS1 or CS2 via the wireless communicator circuitry WC1 using the second communication protocol CP2 in a case where the electronic controller circuitry EC1 maintains use of the second communication protocol CP2. The electronic controller circuitry EC1 is configured to receive the control signal CS1 or CS2 via the wireless communicator circuitry WC1 using the second communication protocol CP2 in a case where the electronic controller circuitry EC1 maintains use of the second communication protocol CP2.

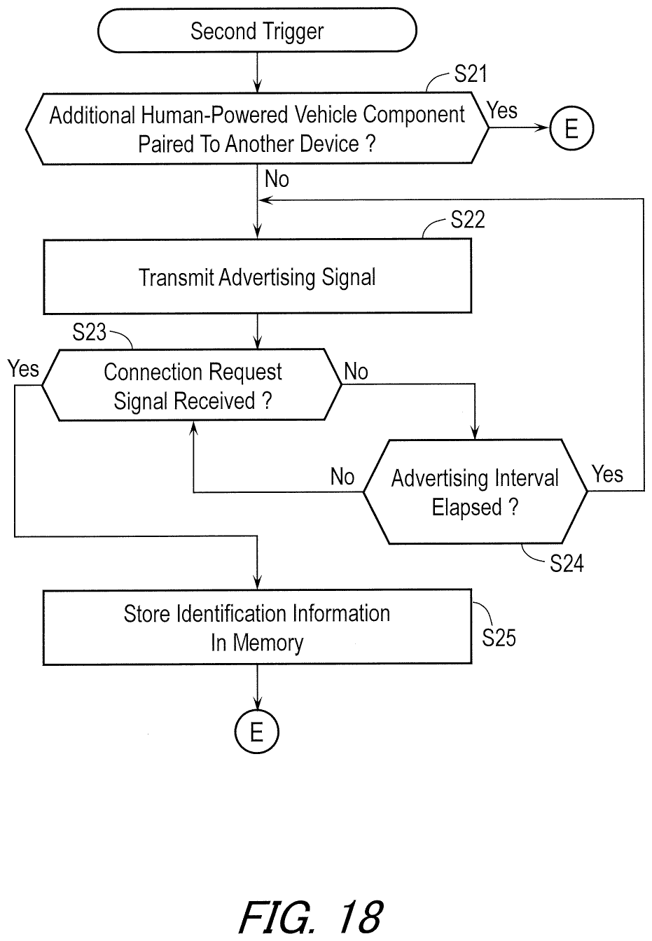

The wireless communication process executed between the human-powered vehicle component BC1 and the additional human-powered vehicle component BC2 will be discussed below referring to FIGS. 15 to 20. FIGS. 15 to 17 show the flowchart of the wireless communication process executed in the human-powered vehicle component BC1. FIGS. 18 to 20 show the flowchart of the wireless communication process executed in the additional human-powered vehicle component BC2.

As seen in FIG. 15, the electronic controller circuitry EC1 starts the pairing process in response to the first trigger. In step S1, the electronic controller circuitry EC1 first determines whether the human-powered vehicle component BC1 has already been paired to another device such as the additional human-powered vehicle component BC2. For example, the electronic controller circuitry EC1 reads the at least one memory EC12 to determine whether identification information of another human-powered vehicle component (e.g., the identification information ID2 of the additional human-powered vehicle component BC2) is stored in the at least one memory EC12.

In a case where the human-powered vehicle component BC1 has not been paired to another device such as the additional human-powered vehicle component BC2, then the electronic controller circuitry EC1 proceeds to step S2. For example, in a case where identification information of another device (e.g., the identification information ID2 of the additional human-powered vehicle component BC2) has not been stored in the at least one memory EC12, then the electronic controller circuitry EC1 controls the wireless communicator circuitry WC1 such that the human-powered vehicle component BC1 starts the pairing process.

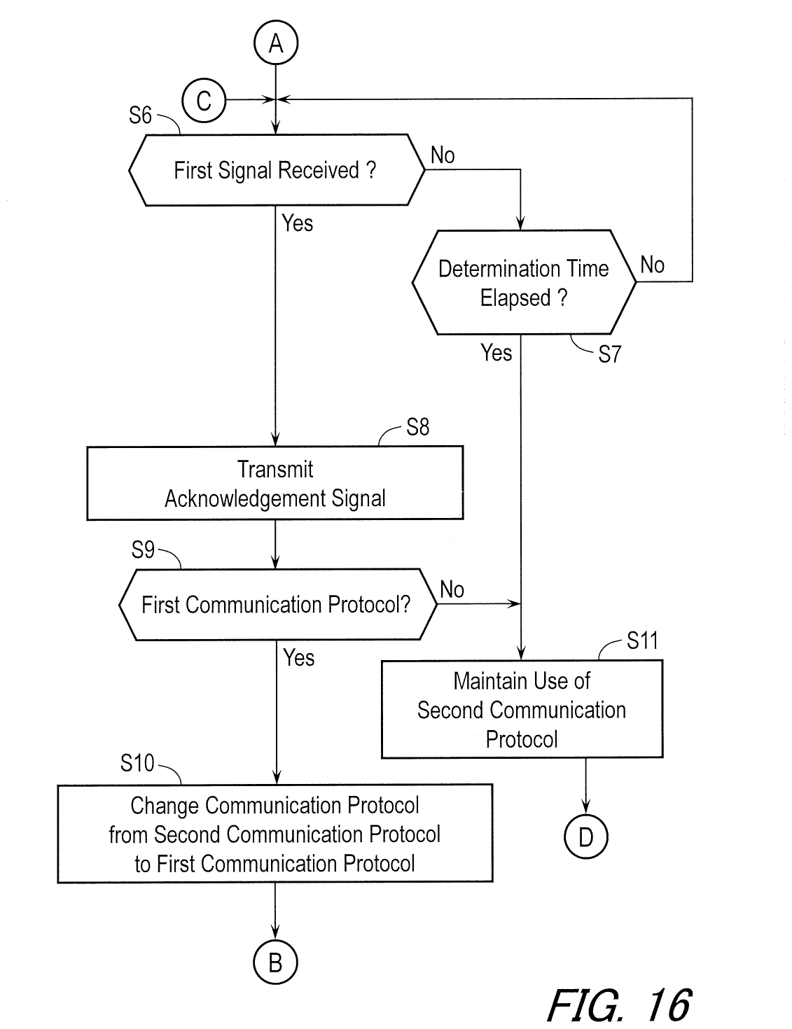

On the other hand, in a case where the human-powered vehicle component BC1 has been paired to another device such as the additional human-powered vehicle component BC2, then the electronic controller circuitry EC1 proceeds to step S6 of FIG. 16. For example, in a case where identification information such as the identification information ID2 of the additional human-powered vehicle component BC2 is already stored in the at least one memory EC12, then the electronic controller circuitry EC1 controls the wireless communicator circuitry WC1 such that the human-powered vehicle component BC1 starts a communication process instead of the pairing process. Accordingly, the electronic controller circuitry EC1 skips the pairing process in a case where the wireless connection is established between the human-powered vehicle component BC1 and the additional human-powered vehicle component BC2.

As seen in FIG. 18, the additional human-powered vehicle component BC2 starts the pairing process in response to the second trigger. In step S21, the additional electronic controller circuitry EC2 second determines whether the additional human-powered vehicle component BC2 has already been paired to another device such as the human-powered vehicle component BC1. For example, the additional electronic controller circuitry EC2 reads the at least one memory EC22 to determine whether the identification information ID1 of the human-powered vehicle component BC1 is stored in the at least one memory EC22.

In a case where the additional human-powered vehicle component BC2 has not been paired to the human-powered vehicle component BC1, then the additional electronic controller circuitry EC2 proceeds to step S22. For example, in a case where the identification information ID1 of the human-powered vehicle component BC1 has not been stored in the at least one memory EC22, then the additional electronic controller circuitry EC2 controls the additional wireless communicator circuitry WC2 such that the additional human-powered vehicle component BC2 starts the pairing process.

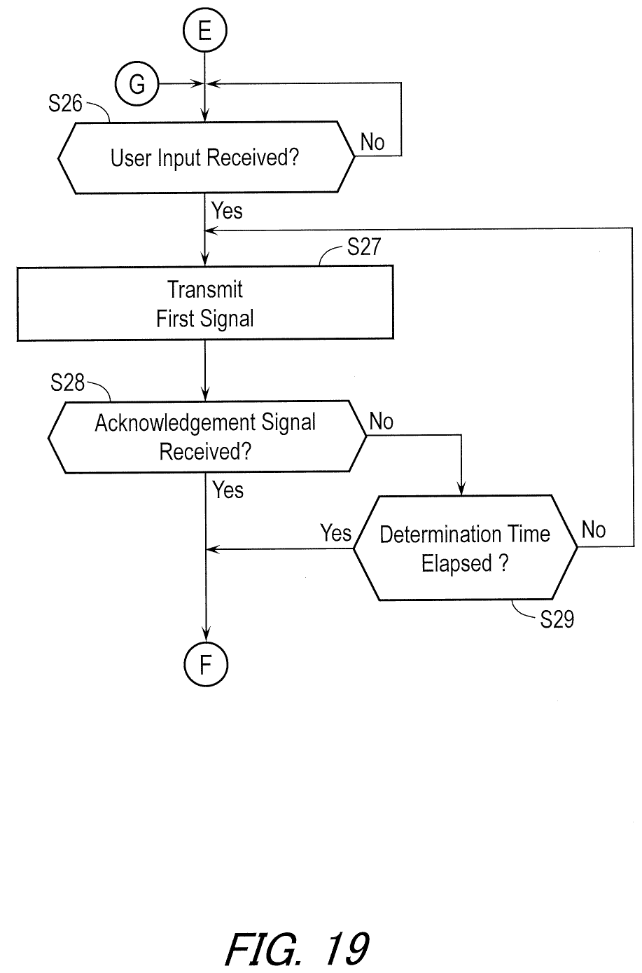

On the other hand, in a case where the additional human-powered vehicle component BC2 has been paired to another device such as the human-powered vehicle component BC1, then the additional electronic controller circuitry EC2 proceeds to step S26 of FIG. 19. For example, in a case where the identification information ID1 of the human-powered vehicle component BC1 is already stored in the at least one memory EC22, then the additional electronic controller circuitry EC2 controls the additional wireless communicator circuitry WC2 such that the additional human-powered vehicle component BC2 enters a communication process instead of the pairing process. Accordingly, the additional electronic controller circuitry EC2 skips the pairing process in a state where pairing is established between the human-powered vehicle component BC1 and the additional human-powered vehicle component BC2.

As seen in FIG. 18, in step S22, the electronic controller circuitry EC2 controls the wireless communicator circuitry WC2 to wirelessly transmit the advertising signal SG1. The advertising signal SG1 includes the identification information ID2 of the additional human-powered vehicle component BC2.

As seen in FIG. 15, in step S2, the electronic controller circuitry EC1 controls the wireless communicator circuitry WC1 to scan the advertising signal SG1. In step S3, the electronic controller circuitry EC1 determines whether the advertisement scanning time has elapsed from the transmission of the advertising signal SG1 in a case where the human-powered vehicle component BC1 does not receive the advertising signal SG1. In a case where the advertisement scanning time has elapsed from the start of the scanning of the advertising signal SG1, the process returns to step S1. In a case where the advertisement scanning time has not elapsed from the transmission of the advertising signal SG1, the process returns to step S2, and then the electronic controller circuitry EC1 controls the wireless communicator circuitry WC1 to continue scanning the advertising signal SG1. The electronic controller circuitry EC1 controls the wireless communicator circuitry WC1 to continue scanning the advertising signal SG1 for the advertisement scanning time until the human-powered vehicle component BC1 wirelessly receives the advertising signal SG1. The process proceeds to step S4 in a case where the wireless communicator circuitry WC1 wirelessly receives the advertising signal SG1.

In step S4, the electronic controller circuitry EC1 stores the identification information ID2 included in the advertising signal SG1 in the at least one memory EC12. For example, the electronic controller circuitry EC1 stores the identification information ID2 included in the advertising signal SG1 in the at least one memory EC12. The process proceeds to step S5.

In step S5, the electronic controller circuitry EC1 controls the wireless communicator circuitry WC1 to wirelessly transmit the connection request signal SG2 in response to the advertising signal SG1.

As seen in FIG. 18, in step S23, the additional electronic controller circuitry EC2 controls the additional wireless communicator circuitry WC2 to scan the connection request signal SG2, which includes the identification information ID1 of the human-powered vehicle component BC1 after the transmission of the advertising signal SG1.

In step S24, the additional electronic controller circuitry EC2 determines whether the advertising interval T1 has elapsed from the transmission of the advertising signal SG1 in a case where the additional human-powered vehicle component BC2 does not receive the connection request signal SG2. In a case where the advertising interval T1 has elapsed from the transmission of the advertising signal SG1, the process returns to step S22, and then the advertising signal SG1 is transmitted again. In a case where the advertising interval T1 has not elapsed from the transmission of the advertising signal SG1, the process returns to step S5, and then the additional electronic controller circuitry EC2 controls the additional wireless communicator circuitry WC2 to continue scanning the connection request signal SG2. The transmission of the advertising signal SG1 and the scanning of the connection request signal SG2 is repeatedly executed until the additional human-powered vehicle component BC2 wirelessly receives the connection request signal SG2. The process proceeds to step S25 in a case where the additional wireless communicator circuitry WC2 wirelessly receives the connection request signal SG2.

In step S25, the additional electronic controller circuitry EC2 stores the identification information ID1 included in the connection request signal SG2 in the at least one memory EC22. For example, the additional electronic controller circuitry EC2 stores the identification information ID1 included in the connection request signal SG2 in the at least one memory EC22. The process proceeds to step S26 in FIG. 19.

As seen in FIG. 19, in step S26, the additional electronic controller circuitry EC2 determines whether the user interface BC21 receives the user input U21 or U22. In step S27, the additional electronic controller circuitry EC2 controls the wireless communicator circuitry WC2 to transmit the first signal SG3 in response to the user input U21 or U22 received by the user interface BC21. The first signal SG3 includes the first information N1 indicative of the first communication protocol CP1.

As seen in FIG. 16, in step S6, the electronic controller circuitry EC1 controls the wireless communicator circuitry WC1 to scan the first signal SG3 after the transmission of the connection request signal SG2.

In step S7, the electronic controller circuitry EC1 determines whether the determination time has elapsed from the transmission of the connection request signal SG2 in a case where the human-powered vehicle component BC1 does not receive the first signal SG3. In a case where the determination time has elapsed from the start of the scanning of the first signal SG3, the process proceeds step S11. In a case where the determination time has not elapsed from the transmission of the connection request signal SG2, the process returns to step S6, and then the electronic controller circuitry EC1 controls the wireless communicator circuitry WC1 to continue scanning the first signal SG3. The electronic controller circuitry EC1 controls the wireless communicator circuitry WC1 to continue scanning the first signal SG3 for the determination time until the human-powered vehicle component BC1 wirelessly receives the first signal SG3. The process proceeds to step S8 in a case where the wireless communicator circuitry WC1 wirelessly receives the first signal SG3.

In step S8, the electronic controller circuitry EC1 controls the wireless communicator circuitry WC1 to transmit the acknowledgement signal SG3A in response to the first signal SG3.

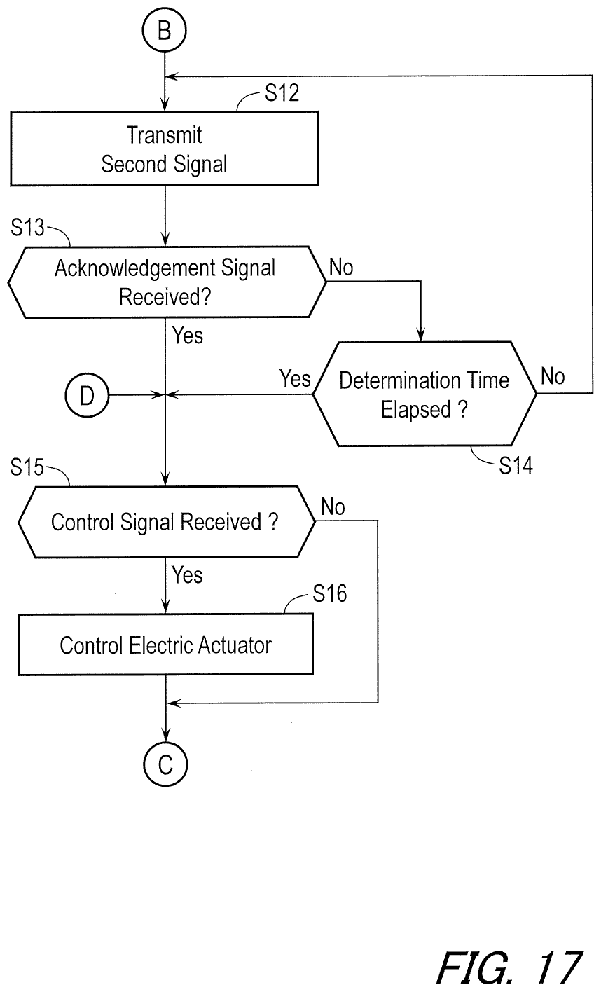

In step S9, the electronic controller circuitry EC1 determines whether the first signal SG3 includes the first information N1 indicative of the first communication protocol CP1. In a case where the first signal SG3 includes the first information N1 indicative of the first communication protocol CP1, in step S10, the electronic controller circuitry EC1 changes the communication protocol from the second communication protocol CP2 to the first communication protocol CP1. The electronic controller circuitry EC1 proceeds to step S12 of FIG. 17.

In a case where the first signal SG3 does not include the first information N1 indicative of the first communication protocol CP1 or where the first information N1 is not indicative of the first communication protocol CP1, in step S11, the electronic controller circuitry EC1 maintains use of the second communication protocol CP2 as the communication protocol. The electronic controller circuitry EC1 proceeds to step S15 of FIG. 17.

As seen in FIG. 17, in step S12, the electronic controller circuitry EC1 controls the wireless communicator circuitry WC1 to transmit the second signal SG4. The second signal SG4 includes the second information N2 indicative of the first communication protocol CP1.

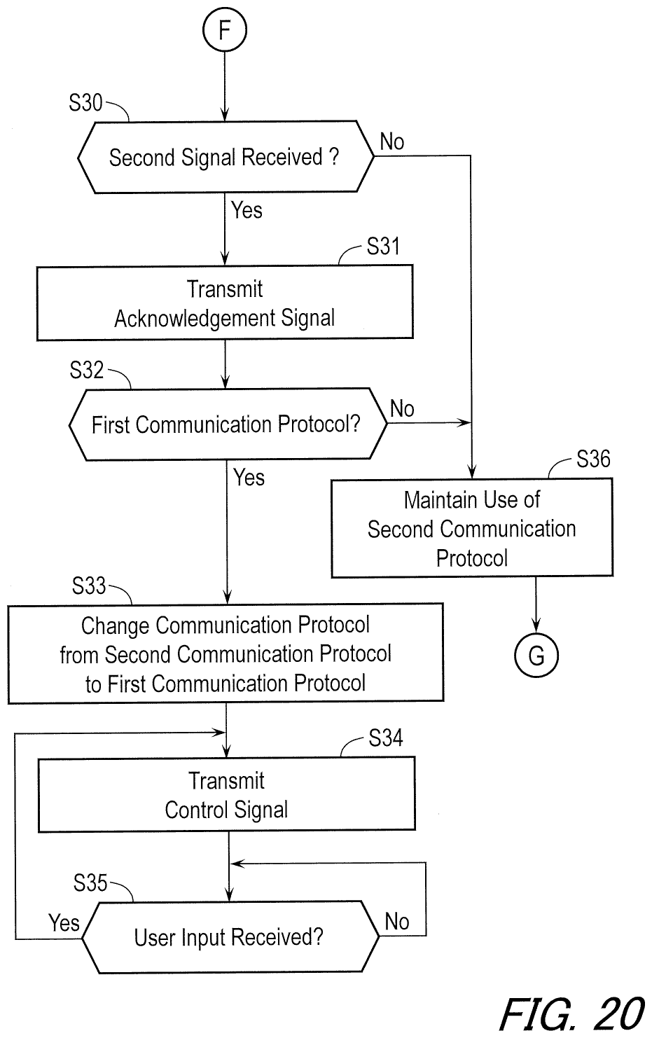

As seen in FIG. 20, in step S30, the additional electronic controller circuitry EC2 control the additional wireless communicator circuitry WC2 to scan the second signal SG4 after the receipt of the acknowledgement signal SG3A.

In step S31, the additional electronic controller circuitry EC2 controls the additional wireless communicator circuitry WC2 to transmit the acknowledgement signal SG4A in a case where the additional wireless communicator circuitry WC2 wirelessly receives the second signal SG4 in step S30. The process proceeds to step S36 in a case where the additional wireless communicator circuitry WC2 does not wirelessly receive the second signal SG4 in step S30.

In step S32, the additional electronic controller circuitry EC2 determines whether the second signal SG4 includes the second information N2 indicative of the first communication protocol CP1. In a case where the second signal SG4 includes the second information N2 indicative of the first communication protocol CP1, in step S33, the additional electronic controller circuitry EC2 changes the communication protocol from the second communication protocol CP2 to the first communication protocol CP1. The additional electronic controller circuitry EC2 proceeds to step S34.

In a case where the second signal SG4 does not include the second information N2 indicative of the first communication protocol CP1 or where the second information N2 is not indicative of the first communication protocol CP1, in step S36, the additional electronic controller circuitry EC2 maintains use of the second communication protocol CP2 as the communication protocol. The additional electronic controller circuitry EC2 proceeds to step S26 of FIG. 19.

In step S34, the additional electronic controller circuitry EC2 controls the wireless communicator circuitry WC2 to transmit the control signal CS1 or CS2. For example, the additional electronic controller circuitry EC2 controls the wireless communicator circuitry WC2 to transmit the control signal CS1 in a case where the additional user interface BC21 receives the user input U21 (e.g., the additional user gear-change input U21A) in step S26 of FIG. 19. The additional electronic controller circuitry EC2 controls the wireless communicator circuitry WC2 to transmit the control signal CS2 in a case where the additional user interface BC21 receives the user input U22 (e.g., the additional user gear-change input U22A) in step S26 of FIG. 19.

As seen in FIG. 17, in step S15, the electronic controller circuitry EC1 controls the wireless communicator circuitry WC1 to scan a control signal such as the control signal CS1 or CS2. In step S16, the electronic controller circuitry EC1 controls the electric actuator 12E. For example, the electronic controller circuitry EC1 controls the electric actuator 12E to upshift in response to the control signal CS1. The electronic controller circuitry EC1 controls the electric actuator 12E to downshift in response to the control signal CS2. The process returns to step S6 of FIG. 16.

As seen in FIG. 20, in step S35, the additional electronic controller circuitry EC2 determines whether the additional user interface BC21 receives the user input U21 or U22 after the transmission of the control signal CS1 or CS2. In step S34, the additional electronic controller circuitry EC2 controls the additional wireless communicator circuitry WC2 to transmit the control signal CS1 or CS2 in a case where the additional user interface BC21 receives the user input U21 or U22 in step S35.

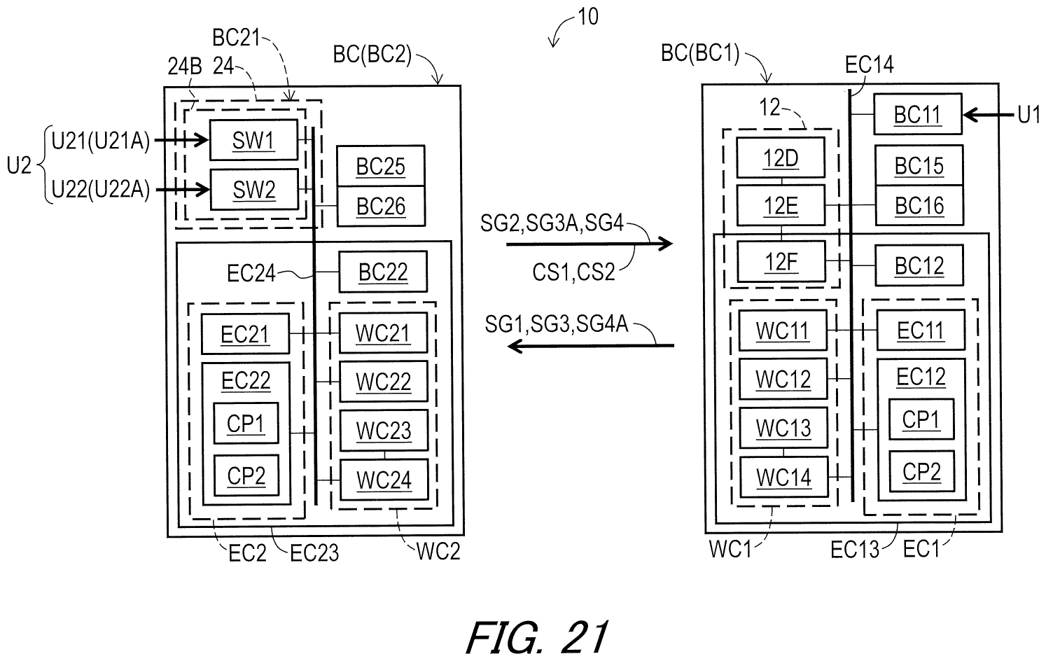

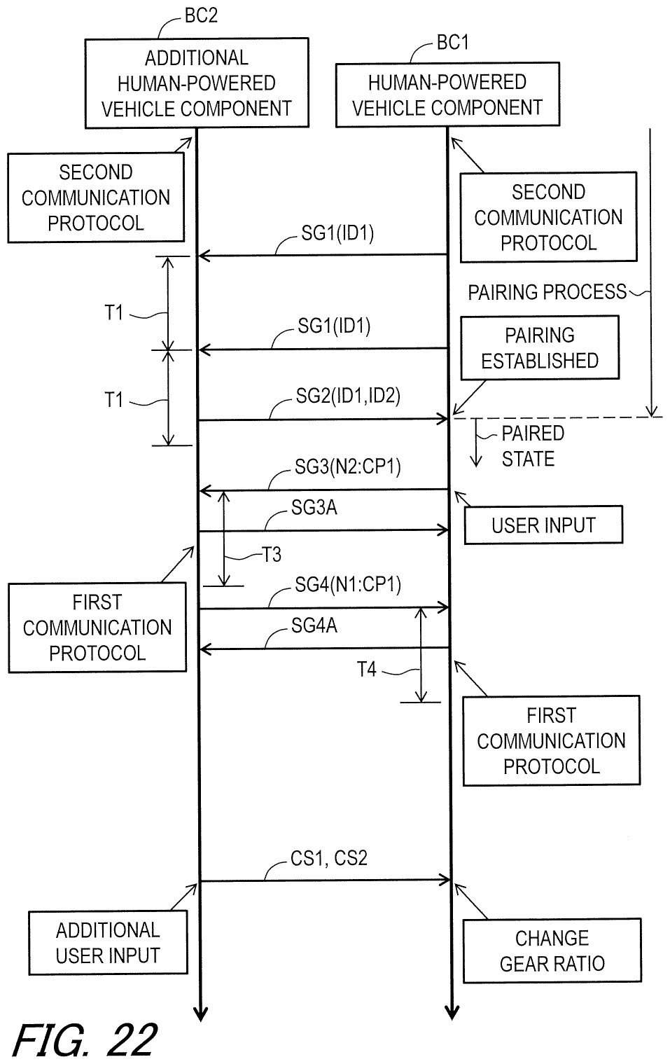

In the present embodiment and the modifications thereof, the additional human-powered vehicle component BC2 is configured to transmit the first or second signal SG3 in response to the user input U21 or U22 received by the user interface BC21. The human-powered vehicle component BC1 is configured to transmit the first or second signal SG4 in response to the first or second signal SG3. As seen in FIGS. 21 and 22, however, the human-powered vehicle component BC1 can be configured to transmit the first or second signal SG3 in response to the user input U1 received by the user interface BC11. The additional human-powered vehicle component BC2 can be configured to transmit the first or second signal SG4 in response to the first or second signal SG3. In the modification, the electronic controller circuitry EC1 is configured to transmit the second signal SG3 wirelessly via the wireless communicator circuitry WC1 in response to the user input U1 received by the user interface BC11. The additional electronic controller circuitry EC2 is configured to receive the second signal SG3 wirelessly via the additional wireless communicator circuitry WC2. The electronic controller circuitry EC1 is configured to transmit the advertising signal SG1 wirelessly via the wireless communicator circuitry WC1 in response to a trigger such as the first trigger or the second trigger. The additional electronic controller circuitry EC2 is configured to receive the advertising signal SG1 wirelessly via the additional wireless communicator circuitry WC2. The additional electronic controller circuitry EC2 is configured to transmit the connection request signal SG2 in response to the advertising signal SG1.

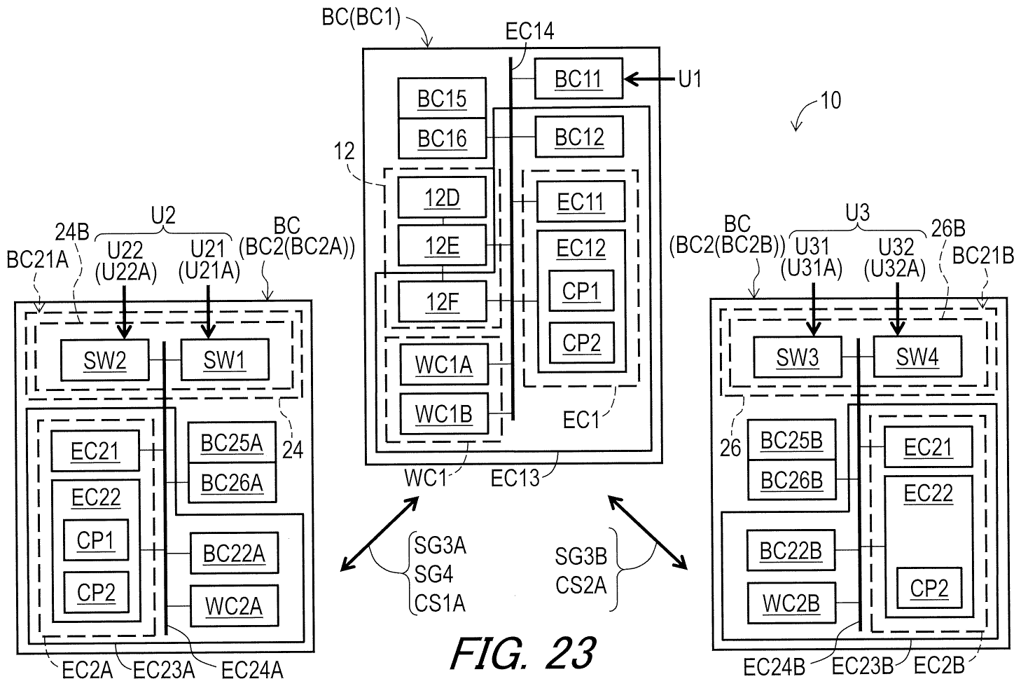

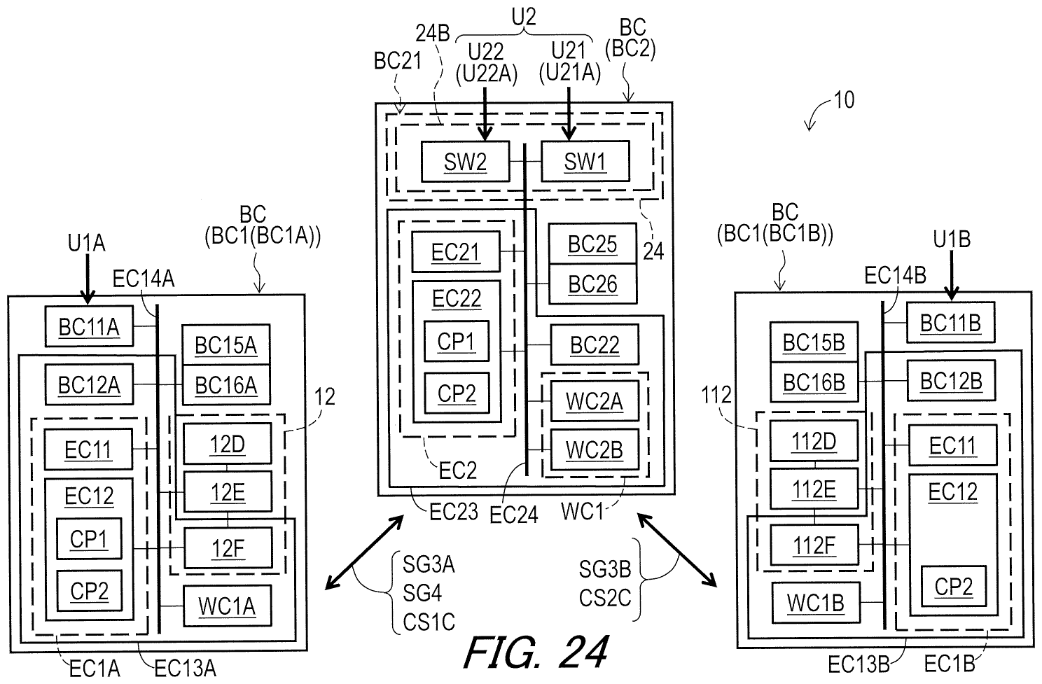

In the present embodiment and the modifications thereof, the human-powered vehicle component BC1 is configured to be paired with the additional human-powered vehicle component BC2. As seen in FIGS. 23 and 24, however, the human-powered vehicle component BC1 or BC2 can be configured to be paired with at least two additional human-powered vehicle components.

In the modification depicted in FIG. 23, the additional human-powered vehicle component BC2 includes a first additional human-powered vehicle component BC2A and a second additional human-powered vehicle component BC2B. The human-powered vehicle component BC1 is configured to be paired with each of the first additional human-powered vehicle component BC2A and the second additional human-powered vehicle component BC2B. The human-powered vehicle component BC1 is configured to wirelessly transmit a signal selectively to one of the first additional human-powered vehicle component BC2A and the second additional human-powered vehicle component BC2B. The human-powered vehicle component BC1 is configured to wirelessly receive a signal selectively from one of the first additional human-powered vehicle component BC2A and the second additional human-powered vehicle component BC2B.

As with the additional human-powered vehicle component BC2 depicted in FIG. 9, the first additional human-powered vehicle component BC2A includes additional electronic controller circuitry EC2A, at least one circuit board EC23A, at least one system bus EC24A, first additional wireless communicator circuitry WC2A, a user interface BC21A, a notification device BC22A, an electric power source BC25A, and a power source holder BC26A. As with the additional human-powered vehicle component BC2 depicted in FIG. 9, the second additional human-powered vehicle component BC2B includes additional electronic controller circuitry EC2A, at least one circuit board EC23A, at least one system bus EC24A, first additional wireless communicator circuitry WC2A, a user interface BC21A, a notification device BC22A, an electric power source BC25A, and a power source holder BC26A. The additional electronic controller circuitry EC2A, the at least one circuit board EC23A, the at least one system bus EC24A, the first additional wireless communicator circuitry WC2A, the user interface BC21A, the notification device BC22A, the electric power source BC25A, and the power source holder BC26A have substantially the same structures as the structures of the additional electronic controller circuitry EC2, the at least one circuit board EC23, the at least one system bus EC24, the additional wireless communicator circuitry WC2, the user interface BC21, the notification device BC22, the electric power source BC25, and the power source holder BC26 of the additional human-powered vehicle component BC2 depicted in FIG. 9. The additional electronic controller circuitry EC2B, the at least one circuit board EC23B, the at least one system bus EC24B, the second additional wireless communicator circuitry WC2B, the user interface BC21B, the notification device BC22B, the electric power source BC25B, and the power source holder BC26B have substantially the same structures as the structures of the additional electronic controller circuitry EC2, the at least one circuit board EC23, the at least one system bus EC24, the additional wireless communicator circuitry WC2, the user interface BC21, the notification device BC22, the electric power source BC25, and the power source holder BC26 of the additional human-powered vehicle component BC2 depicted in FIG. 9.

The wireless communicator circuitry WC1 is configured to communicate wirelessly with the first additional wireless communicator circuitry WC2A of the first additional human-powered vehicle component BC2A and the second additional wireless communicator circuitry WC2B of the second additional human-powered vehicle component BC2B. The first additional wireless communicator circuitry WC2A is configured to use the first communication protocol CP1. The second additional wireless communicator circuitry WC2B is configured to use the second communication protocol CP2. In the modification, each of the first additional human-powered vehicle component BC2A and the second additional human-powered vehicle component BC2B has only a function relating to the human-powered vehicle B. Alternatively, at least one of the first additional human-powered vehicle component BC2A and the second additional human-powered vehicle component BC2B can have a function other than a function relating to the human-powered vehicle B. For example, at least one of the first additional human-powered vehicle component BC2A and the second additional human-powered vehicle component BC2B can include an electric device such as a cycle computer, a smartphone, a tablet computer, a personal computer, and a wearable device.

As seen in FIG. 23, the electronic controller circuitry EC1 is configured to cause the human-powered vehicle component BC1 to be in a paired state where the human-powered vehicle component BC1 is paired with both the first additional human-powered vehicle component BC2A and the second additional human-powered vehicle component BC2B.

For example, the pairing process depicted in FIGS. 10, 12, and 14 to 20 is executed between the human-powered vehicle component BC1 and the first additional human-powered vehicle component BC2A via the wireless communicator circuitry WC1 and the first additional wireless communicator circuitry WC2A. Furthermore, the pairing process depicted in FIGS. 10, 12, and 14 to 20 is executed between the human-powered vehicle component BC1 and the second additional human-powered vehicle component BC2B via the wireless communicator circuitry WC1 and the second additional wireless communicator circuitry WC2B.

As seen in FIG. 23, for example, the wireless communicator circuitry WC1 includes first wireless communicator circuitry WC1A and second wireless communicator circuitry WC1B. The first wireless communicator circuitry WC1A is configured to communicate wirelessly with the first additional wireless communicator circuitry WC2A. The second wireless communicator circuitry WC1B is configured to communicate wirelessly with the second additional wireless communicator circuitry WC2B. The first wireless communicator circuitry WC1A has substantially the same structure as the structure of the wireless communicator circuitry WC1 depicted in FIG. 9. The second wireless communicator circuitry WC1B has substantially the same structure as the structure of the wireless communicator circuitry WC1 depicted in FIG. 9. Alternatively, the wireless communicator circuitry WC1 can be single communicator circuitry. In a case where each of the first additional human-powered vehicle component BC2A and the second additional human-powered vehicle component BC2B has only a function relating to the human-powered vehicle B, the wireless communicator circuitry WC1 can include other wireless communicator circuitry, which is configured to wirelessly communicate with another device (e.g., a cycle computer, a smartphone, a tablet computer, a personal computer, and a wearable device) having a function other than the function relating to the human-powered vehicle B, in addition to the first wireless communicator circuitry WC1A and the second wireless communicator circuitry WC1B.

In a case where the wireless communicator circuitry WC1 includes the first wireless communicator circuitry WC1A and the second wireless communicator circuitry WC1B, the pairing process depicted in FIGS. 10, 12, and 14 to 20 is executed between the human-powered vehicle component BC1 and the first additional human-powered vehicle component BC2A via the first wireless communicator circuitry WC1A and the first additional wireless communicator circuitry WC2A and is executed between the human-powered vehicle component BC1 and the second additional human-powered vehicle component BC2B via the second wireless communicator circuitry WC1B and the second additional wireless communicator circuitry WC2B.

The electronic controller circuitry EC1 is configured to receive a first signal SG3A and/or SG3B from at least one of the first additional wireless communicator circuitry WC2A and the second additional wireless communicator circuitry WC2B via the wireless communicator circuitry WC1. In a case where the wireless communicator circuitry WC1 includes the first wireless communicator circuitry WC1A and the second wireless communicator circuitry WC1B, the electronic controller circuitry EC1 is configured to receive the first signal SG3A from the first additional wireless communicator circuitry WC2A via the first wireless communicator circuitry WC1A and is configured to receive the first signal SG3B from the second additional wireless communicator circuitry WC2B via the second wireless communicator circuitry WC1B. The first signal SG3A includes information indicative of the first communication protocol CP1 in a case where the first additional human-powered vehicle component BC2A is compatible with the first communication protocol CP1 and the second communication protocol CP2. The first signal SG3B does not include information indicative of the first communication protocol CP1 in a case where the second additional human-powered vehicle component BC2B is not compatible with the first communication protocol CP1.

The electronic controller circuitry EC1 is configured to transmit the second signal SG4 to at least one of the first additional wireless communicator circuitry WC2A and the second additional wireless communicator circuitry WC2B via the wireless communicator circuitry WC1. The second signal SG4 includes information indicative of the first communication protocol CP1 in a case where the human-powered vehicle component BC1 is compatible with the first communication protocol CP1 and the second communication protocol CP2. The communication between the human-powered vehicle component BC1 and the first additional human-powered vehicle component BC2A corresponds to the first scenario depicted in FIGS. 9 and 10. In a case where the wireless communicator circuitry WC1 includes the first wireless communicator circuitry WC1A and the second wireless communicator circuitry WC1B, the electronic controller circuitry EC1 is configured to transmit the second signal SG4 to the first additional wireless communicator circuitry WC2A via the first wireless communicator circuitry WC1A. In a case where the second additional human-powered vehicle component BC2B is not compatible with the first communication protocol CP1, however, the electronic controller circuitry EC1 does not transmit the second signal SG4. The communication between human-powered vehicle component BC1 and the second additional human-powered vehicle component BC2B corresponds to the second scenario depicted in FIGS. 11 and 12.

As seen in FIG. 23, for example, the first additional human-powered vehicle component BC2A includes the operating device 24. The second additional human-powered vehicle component BC2B includes the operating device 26. The human-powered vehicle component BC1 includes at least one of the human-powered vehicle components BC such as the gear changer 12. The human-powered vehicle component BC1 is configured to be operated based on each of: the first user input U2 received by the first additional human-powered vehicle component BC2A; and a second user input U3 received by the second additional human-powered vehicle component BC2B. The second user input U3 includes the user input U31 and/or U32. The electronic controller circuitry EC1 is configured to receive a first control signal CS1A indicative of the first user input U2 from the first additional wireless communicator circuitry WC2A using the first communication protocol CP1. The electronic controller circuitry EC1 is configured to control the gear changer 12 based on the first control signal CS1A. The electronic controller circuitry EC1 is configured to receive a second control signal CS2A indicative of the second user input U3 from the second additional wireless communicator circuitry WC2B using the second communication protocol CP2. The electronic controller circuitry EC1 is configured to control the gear changer 12 based on the second control signal CS1B.

In the modification depicted in FIG. 24, the additional human-powered vehicle component BC1 includes a first additional human-powered vehicle component BC1A and a second additional human-powered vehicle component BC1B. The human-powered vehicle component BC2 is configured to be paired with each of the first additional human-powered vehicle component BC1A and the second additional human-powered vehicle component BC1B. The human-powered vehicle component BC2 is configured to wirelessly transmit a signal selectively to one of the first additional human-powered vehicle component BC1A and the second additional human-powered vehicle component BC1B. The human-powered vehicle component BC2 is configured to wirelessly receive a signal selectively from one of the first additional human-powered vehicle component BC1A and the second additional human-powered vehicle component BC1B.

As with the additional human-powered vehicle component BC1 depicted in FIG. 9, the first additional human-powered vehicle component BC1A includes additional electronic controller circuitry EC1A, at least one circuit board EC13A, at least one system bus EC14A, first additional wireless communicator circuitry WC1A, a user interface BC11A, a notification device BC12A, an electric power source BC15A, and a power source holder BC16A. As with the additional human-powered vehicle component BC1 depicted in FIG. 9, the second additional human-powered vehicle component BC1B includes additional electronic controller circuitry EC1B, at least one circuit board EC13 B, at least one system bus EC14B, first additional wireless communicator circuitry WC1B, a user interface BC11B, a notification device BC12B, an electric power source BC15B, and a power source holder BC16B. The additional electronic controller circuitry EC1A, the at least one circuit board EC13A, the at least one system bus EC14A, the first additional wireless communicator circuitry WC1A, the user interface BC11A, the notification device BC12A, the electric power source BC15A, and the power source holder BC16A have substantially the same structures as the structures of the electronic controller circuitry EC1, the at least one circuit board EC13, the at least one system bus EC14, the wireless communicator circuitry WC1, the user interface BC11, the notification device BC12, the electric power source BC15, and the power source holder BC16 of the additional human-powered vehicle component BC1 depicted in FIG. 9. The additional electronic controller circuitry EC1B, the at least one circuit board EC13B, the at least one system bus EC14B, the second additional wireless communicator circuitry WC1B, the user interface BC11B, the notification device BC12B, the electric power source BC15B, and the power source holder BC16B have substantially the same structures as the structures of the electronic controller circuitry EC1, the at least one circuit board EC13, the at least one system bus EC14, the wireless communicator circuitry WC1, the user interface BC11, the notification device BC12, the electric power source BC15, and the power source holder BC16 of the additional human-powered vehicle component BC1 depicted in FIG. 9.

The wireless communicator circuitry WC2 is configured to communicate wirelessly with the first additional wireless communicator circuitry WC1A of the first additional human-powered vehicle component BC1A and the second additional wireless communicator circuitry WC1B of the second additional human-powered vehicle component BC1B. The first additional wireless communicator circuitry WC1A is configured to use the first communication protocol CP1. The second additional wireless communicator circuitry WC1B is configured to use the second communication protocol CP2. In the modification, each of the first additional human-powered vehicle component BC1A and the second additional human-powered vehicle component BC1B has only a function relating to the human-powered vehicle B. Alternatively, at least one of the first additional human-powered vehicle component BC1A and the second additional human-powered vehicle component BC1B can have a function other than a function relating to the human-powered vehicle B. For example, at least one of the first additional human-powered vehicle component BC1A and the second additional human-powered vehicle component BC1B can include an electric device such as a cycle computer, a smartphone, a tablet computer, a personal computer, and a wearable device.

As seen in FIG. 24, the electronic controller circuitry EC2 is configured to cause the human-powered vehicle component BC2 to be in a paired state where the human-powered vehicle component BC2 is paired with both the first additional human-powered vehicle component BC1A and the second additional human-powered vehicle component BC1B.

For example, the pairing process depicted in FIGS. 10, 12, and 14 to 20 is executed between the human-powered vehicle component BC2 and the first additional human-powered vehicle component BC1A via the wireless communicator circuitry WC2 and the first additional wireless communicator circuitry WC1A. Furthermore, the pairing process depicted in FIGS. 10, 12, and 14 to 20 is executed between the human-powered vehicle component BC2 and the second additional human-powered vehicle component BC1B via the wireless communicator circuitry WC2 and the second additional wireless communicator circuitry WC1B.

As seen in FIG. 24, for example, the wireless communicator circuitry WC2 includes first wireless communicator circuitry WC2A and second wireless communicator circuitry WC2B. The first wireless communicator circuitry WC2A is configured to communicate wirelessly with the first additional wireless communicator circuitry WC1A. The second wireless communicator circuitry WC2B is configured to communicate wirelessly with the second additional wireless communicator circuitry WC1B. The first wireless communicator circuitry WC2A has substantially the same structure as the structure of the wireless communicator circuitry WC2 depicted in FIG. 9. The second wireless communicator circuitry WC2B has substantially the same structure as the structure of the wireless communicator circuitry WC2 depicted in FIG. 9. Alternatively, the wireless communicator circuitry WC2 can be single communicator circuitry. In a case where each of the first additional human-powered vehicle component BC1A and the second additional human-powered vehicle component BC1B has only a function relating to the human-powered vehicle B, the wireless communicator circuitry WC2 can include other wireless communicator circuitry, which is configured to wirelessly communicate with another device (e.g., a cycle computer, a smartphone, a tablet computer, a personal computer, and a wearable device) having a function other than the function relating to the human-powered vehicle B, in addition to the first wireless communicator circuitry WC2A and the second wireless communicator circuitry WC2B.

In a case where the wireless communicator circuitry WC2 includes the first wireless communicator circuitry WC2A and the second wireless communicator circuitry WC2B, the pairing process depicted in FIGS. 10, 12, and 14 to 20 is executed between the human-powered vehicle component BC2 and the first additional human-powered vehicle component BC1A via the first wireless communicator circuitry WC2A and the first additional wireless communicator circuitry WC1A and is executed between the human-powered vehicle component BC2 and the second additional human-powered vehicle component BC1B via the second wireless communicator circuitry WC2B and the second additional wireless communicator circuitry WC1B.

The electronic controller circuitry EC2 is configured to receive a first signal SG3A and/or SG3B from at least one of the first additional wireless communicator circuitry WC1A and the second additional wireless communicator circuitry WC1B via the wireless communicator circuitry WC2. In a case where the wireless communicator circuitry WC2 includes the first wireless communicator circuitry WC2A and the second wireless communicator circuitry WC2B, the electronic controller circuitry EC2 is configured to receive the first signal SG3A from the first additional wireless communicator circuitry WC1A via the first wireless communicator circuitry WC2A and is configured to receive the first signal SG3B from the second additional wireless communicator circuitry WC1B via the second wireless communicator circuitry WC2B. The first signal SG3A includes information indicative of the first communication protocol CP1 in a case where the first additional human-powered vehicle component BC1A is compatible with the first communication protocol CP1. The first signal SG3B does not include information indicative of the first communication protocol CP1 in a case where the second additional human-powered vehicle component BC1B is not compatible with the first communication protocol CP1.

The electronic controller circuitry EC2 is configured to transmit the second signal SG4 to at least one of the first additional wireless communicator circuitry WC1A and the second additional wireless communicator circuitry WC1B via the wireless communicator circuitry WC2. The second signal SG4 includes information indicative of the first communication protocol CP1 in a case where the additional human-powered vehicle component BC2 is compatible with the first communication protocol CP1 and the second communication protocol CP2. The communication between the first additional human-powered vehicle component BC1A and the additional human-powered vehicle component BC2 corresponds to the first scenario depicted in FIGS. 9 and 10. In a case where the wireless communicator circuitry WC2 includes the first wireless communicator circuitry WC2A and the second wireless communicator circuitry WC2B, the electronic controller circuitry EC2 is configured to transmit the second signal SG4A to the first additional wireless communicator circuitry WC1A via the first wireless communicator circuitry WC2A. In a case where the second additional human-powered vehicle component BC1B is not compatible with the first communication protocol CP1, however, the electronic controller circuitry EC2 does not transmit the second signal SG4. The communication between the second additional human-powered vehicle component BC1B and the additional human-powered vehicle component BC2 corresponds to the second scenario depicted in FIGS. 11 and 12.

As seen in FIG. 24, the human-powered vehicle component BC2 can comprise the operating device 24. The operating device 24 is configured to receive: the first user input U21 to operate the first additional human-powered vehicle component BC1A; and the second user input U22 to operate the second additional human-powered vehicle component BC1B. The first additional human-powered vehicle component BC1A includes one of the human-powered vehicle components BC such as the gear changer 12. The second additional human-powered vehicle component BC1B includes another of the human-powered vehicle components BC such as an additional gear changer 112. For example, the additional gear changer 112 includes a front derailleur. The additional gear changer 112 includes a chain guide 112D, an electric actuator 112E, and an actuator driver 112F.

The electronic controller circuitry EC2 is configured to transmit a first control signal CS1C indicative of the first user input U21 or U22 via the wireless communicator circuitry WC2 using the first communication protocol CP1. The electronic controller circuitry EC1A is configured to control the gear changer 12 based on the first control signal CS1C. The electronic controller circuitry EC2 is configured to transmit a second control signal CS2C indicative of the second user input U31 or U32 via the wireless communicator circuitry WC2 using the second communication protocol CP2. The electronic controller circuitry EC1B is configured to control the additional gear changer 112 based on the second control signal CS2C.

In the modifications illustrated in FIGS. 23 and 24, the human-powered vehicle component BC1 can be configured to communicate concurrently with both the first additional human-powered vehicle component BC3 and the second additional human-powered vehicle component BC4. The human-powered vehicle component BC1 can be configured to communicate concurrently with only one of the first additional human-powered vehicle component BC3 and the second additional human-powered vehicle component BC4.

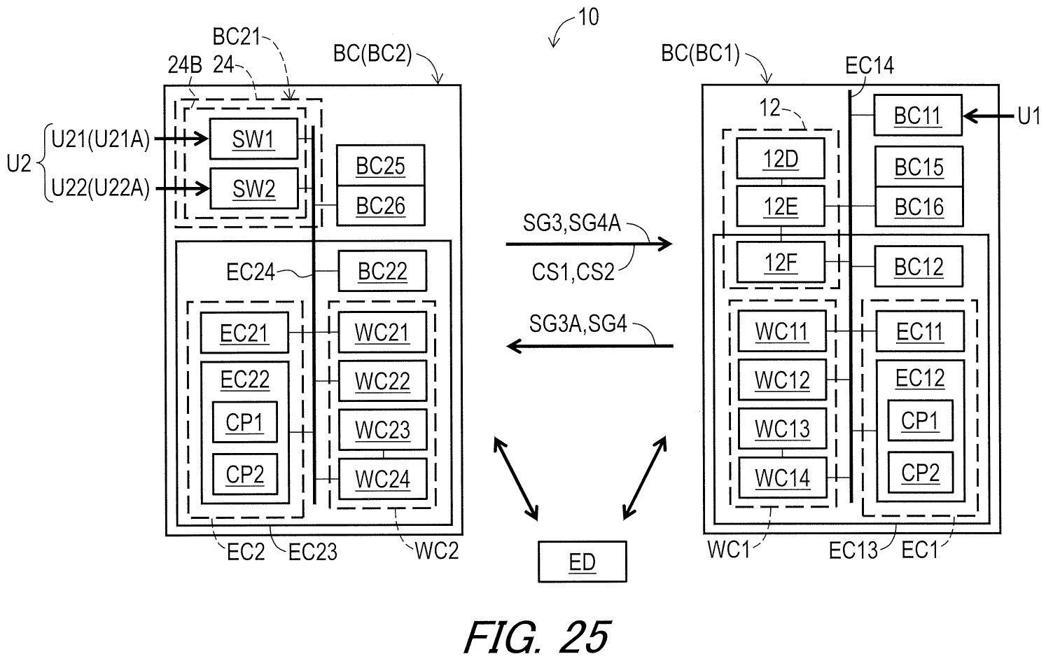

In the present embodiment and the modifications thereof, the pairing process is executed to exchange the identification information between the human-powered vehicle component BC1 and the additional human-powered vehicle component BC2. However, the exchange of the identification information can be executed in a different manner. As seen in FIG. 25, for example, the exchange of the identification information can be executed between the human-powered vehicle component BC1 and the additional human-powered vehicle component BC2 using an external device ED such as a cycle computer, a smartphone, a tablet computer, a personal computer, and a wearable device. Each of the human-powered vehicle component BC1 and the additional human-powered vehicle component BC2 can be configured to enter the paring process in response to a signal transmitted from the external device ED. Alternatively, the human-powered vehicle component BC1 can be configured to transmit the identification information ID1 to the additional human-powered vehicle component BC2 via the external device ED. The additional human-powered vehicle component BC2 can be configured to transmit the identification information ID2 to the human-powered vehicle component BC1 via the external device ED.

In the present embodiment and the modifications thereof, the human-powered vehicle component BC1 is compatible with the first communication protocol CP1 and the second communication protocol CP2. However, the human-powered vehicle component BC1 can be compatible with the first communication protocol CP1, the second communication protocol CP2, and at least one additional communication protocol.

In the present embodiment and the modifications thereof, as seen in FIG. 10, the electronic controller circuitry EC1 changes the communication protocol from the second communication protocol CP2 to the first communication protocol CP1 immediately after receiving the first signal SG3 or transmitting the acknowledgement signal SG3A. Alternatively, the electronic controller circuitry EC1 can be configured to change the communication protocol from the second communication protocol CP2 to the first communication protocol CP1 immediately after transmitting the second signal SG4 or receiving the acknowledgement signal SG4A. In such modifications, the electronic controller circuitry EC1 transmits the second signal SG4 wirelessly via the wireless communicator circuitry WC1 using the second communication protocol CP2 rather than the first communication protocol CP1.

In the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “pair of,” as used herein, can encompass the configuration in which the pair of elements have different shapes or structures from each other in addition to the configuration in which the pair of elements have the same shapes or structures as each other.

The terms “a” (or “an”), “one or more” and “at least one” can be used interchangeably herein.

The phrase “at least one of” as used in this disclosure means “one or more” of a desired choice. For one example, the phrase “at least one of” as used in this disclosure means “only one single choice” or “both of two choices” if the number of its choices is two. For other example, the phrase “at least one of” as used in this disclosure means “only one single choice” or “any combination of equal to or more than two choices” if the number of its choices is equal to or more than three. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Finally, terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Obviously, numerous modifications and variations of the present invention are possible in light of the above teachings. It is therefore to be understood that within the scope of the appended claims, the invention may be practiced otherwise than as specifically described herein.

What is claimed is:

1. A human-powered vehicle component comprising:
wireless communicator circuitry configured to communicate wirelessly with additional wireless communicator circuitry of an additional human-powered vehicle component;
electronic controller circuitry electrically connected to the wireless communicator circuitry and configured to receive a first signal from the additional wireless communicator circuitry via the wireless communicator circuitry, the electronic controller circuitry being configured to store a first communication protocol and a second communication protocol as a communication protocol of the wireless communicator circuitry;
the electronic controller circuitry being configured to change the communication protocol of the wireless communicator circuitry from the second communication protocol to the first communication protocol based on the first signal in a case where the first signal includes first information indicative of the first communication protocol; and
the electronic controller circuitry being configured to control the wireless communicator circuitry to maintain use of the second communication protocol in a case where the electronic controller circuitry does not receive, via the wireless communicator circuitry, the first signal including the first information indicative of the first communication protocol.

2. The human-powered vehicle component according to claim 1, wherein
the electronic controller circuitry is configured to control the wireless communicator circuitry to use the second communication protocol before receipt of the first signal in a paired state where the human-powered vehicle component is paired with the additional human-powered vehicle component, and
the electronic controller circuitry is configured to change the communication protocol of the wireless communicator circuitry from the second communication protocol to the first communication protocol based on the first signal in a case where the first signal includes the first information indicative of the first communication protocol in a paired state where the human-powered vehicle component is paired with the additional human-powered vehicle component.

3. The human-powered vehicle component according to claim 1, wherein
the electronic controller circuitry is configured to control the wireless communicator circuitry to use a pairing protocol in a pairing process regardless of whether the additional human-powered vehicle component is configured to use the first communication protocol or the second communication protocol.

4. The human-powered vehicle component according to claim 1, wherein
the additional human-powered vehicle component includes a first additional human-powered vehicle component and a second additional human-powered vehicle component,
the wireless communicator circuitry is configured to communicate wirelessly with first additional wireless communicator circuitry of the first additional human-powered vehicle component and second additional wireless communicator circuitry of the second additional human-powered vehicle component, the first additional wireless communicator circuitry being configured to use the first communication protocol, the second additional wireless communicator circuitry being configured to use the second communication protocol, and
the electronic controller circuitry is configured to cause the human-powered vehicle component to be in a paired state where the human-powered vehicle component is paired with both the first additional human-powered vehicle component and the second additional human-powered vehicle component.

5. A human-powered vehicle component comprising:
wireless communicator circuitry configured to communicate wirelessly with first additional wireless communicator circuitry of a first additional human-powered vehicle component and second additional wireless communicator circuitry of a second additional human-powered vehicle component, the first additional wireless communicator circuitry being configured to use a first communication protocol, the second additional wireless communicator circuitry being configured to use a second communication protocol, each of the first additional human-powered vehicle component and the second additional human-powered vehicle component having only a function relating to a human-powered vehicle;
electronic controller circuitry electrically connected to the wireless communicator circuitry and configured to receive a first signal from at least one of the first additional wireless communicator circuitry and the second additional wireless communicator circuitry via the wireless communicator circuitry; and
the electronic controller circuitry being configured to cause the human-powered vehicle component to be in a paired state where the human-powered vehicle component is paired with both the first additional human-powered vehicle component and the second additional human-powered vehicle component.

6. The human-powered vehicle component according to claim 5, wherein
the human-powered vehicle component is configured to be operated based on each of
a first user input received by the first additional human-powered vehicle component, and
a second user input received by the second additional human-powered vehicle component, wherein
the electronic controller circuitry is configured to receive a first control signal indicative of the first user input from the first additional wireless communicator circuitry using the first communication protocol, and
the electronic controller circuitry is configured to receive a second control signal indicative of the second user input from the second additional wireless communicator circuitry using the second communication protocol.

7. The human-powered vehicle component according to claim 5, further comprising
an operating device configured to receive
a first user input to operate the first additional human-powered vehicle component, and
a second user input to operate the second additional human-powered vehicle component, wherein
the electronic controller circuitry is configured to transmit a first control signal indicative of the first user input via the wireless communicator circuitry using the first communication protocol, and
the electronic controller circuitry is configured to transmit a second control signal indicative of the second user input via the wireless communicator circuitry using the second communication protocol.

8. The human-powered vehicle component according to claim 1, wherein
the electronic controller circuitry is configured to transmit wirelessly, via the wireless communicator circuitry, a second signal including second information indicative of the first communication protocol.

9. The human-powered vehicle component according to claim 8, wherein
the electronic controller circuitry is configured to wirelessly receive, via the wireless communicator circuitry, the first signal transmitted using the second communication protocol,
the first signal includes the first information indicative of the first communication protocol,
the electronic controller circuitry is configured to wirelessly transmit the second signal using the first communication protocol via the wireless communicator circuitry, and
the second signal includes second information indicative of the first communication protocol.

10. The human-powered vehicle component according to claim 9, wherein
the additional human-powered vehicle component is configured to wirelessly transmit the first signal in response to an additional user input received by an additional user interface of the additional human-powered vehicle component.

11. The human-powered vehicle component according to claim 10, wherein
the additional user interface is configured to receive an additional user gear-change input.

12. The human-powered vehicle component according to claim 8, wherein
the electronic controller circuitry is configured to wirelessly transmit the second signal using the second communication protocol via the wireless communicator circuitry.

13. The human-powered vehicle component according to claim 8, further comprising
a user interface configured to receive a user input, wherein
the electronic controller circuitry is configured to transmit the second signal wirelessly via the wireless communicator circuitry in response to the user input received by the user interface.

14. The human-powered vehicle component according to claim 13, wherein
the user interface is configured to receive a user gear-change input, and
the electronic controller circuitry is configured to transmit the first signal wirelessly via the wireless communicator circuitry in response to the user gear-change input received by the user interface.

15. The human-powered vehicle component according to claim 1, wherein
the electronic controller circuitry is configured to transmit an acknowledgement signal via the wireless communicator circuitry in response to the first signal regardless of whether the first signal includes first information indicative of the first communication protocol or the second communication protocol.

16. The human-powered vehicle component according to claim 1, wherein
the electronic controller circuitry is configured to maintain use of the second communication protocol based on the first signal in a case where the first signal includes first information indicative of the second communication protocol.

17. The human-powered vehicle component according to claim 1, wherein
the electronic controller circuitry is configured to transmit or receive a control signal via the wireless communicator circuitry using the first communication protocol after the electronic controller circuitry changes the communication protocol from the second communication protocol to the first communication protocol, and
the electronic controller circuitry is configured to transmit or receive a control signal via the wireless communicator circuitry using the second communication protocol in a case where the electronic controller circuitry maintains use of the second communication protocol.

18. The human-powered vehicle component according to claim 1, wherein
a version of the first communication protocol is newer than a version of the second communication protocol.

19. A human-powered vehicle system comprising:
the human-powered vehicle component according to claim 1; and
the additional human-powered vehicle component.
